(19) United States
(12) Patent Application Publication
(10) Pub. No.: US 2002/0120485 A1
(43) Pub. Date: Aug. 29, 2002

(54) System and method for aiding customers in defining problems and finding solutions

(76) Inventors: Nancy Kirkconnell-Ewing, Boynton Beach, FL (US); Kyle Neal, Coral Spring, FL (US); Lynn Sauder, Alpharetta, GA (US)

Correspondence Address: HEWLETT-PACKARD COMPANY, Intellectual Property Administration, P.O. Box 272400, Fort Collins, CO, 80527-2400, US

(21) Appl. No.: 09/796,165

(22) Filed: Feb. 28, 2001

(51) Int. Cl. G06F 17/60

(52) U.S. Cl. 705/8

(57) ABSTRACT

The present disclosure relates to a system and method for aiding customers. In one embodiment, the method comprises the steps of prompting the customer in a problem defining process to provide information about issues relevant to its business and a problem the customer is experiencing, receiving customer responses to the prompts, automatically determining a potential solution to the customer problem based upon the customer responses, presenting a description of the potential solution to the customer for review.

### FIELD OF THE INVENTION

The present disclosure relates to a system and method for aiding customers. More particularly, the disclosure relates to a system and method through which customers can receive help in defining the business problems they have and in finding appropriate solutions to the problems.

### BACKGROUND OF THE INVENTION

Most business concerns use computer equipment and software in the daily operations of their businesses. For many medium to large size concerns, this equipment and software is obtained from value-added resellers (VARs). VARs typically determine the concern's equipment/software needs and then provide them with an appropriate business solution. In creating the solutions, the VARs normally obtain equipment (e.g., computers, peripheral devices, etc.) from an equipment vendor and add value to the equipment in some way, for instance, by adding software or other equipment that the VAR believes will be useful to the business concern. In addition, the VAR often configures the equipment/software to suit the specific needs of the business concern.

As the rate of technological innovation continues to increase, so too does the rate at which the equipment sold to businesses by VARs becomes obsolete. Due to this increasing rate of equipment obsolescence and to the increasing numbers of equipment vendors in the market, VAR margins (i.e., the difference between what the VAR pays for the equipment and the amount the VAR sells the equipment for to the end-user) are narrowing quickly. This situation has caused many VARs to search for new ways to generate revenue in the market.

In addition to narrowing VAR margins, equipment obsolescence has also contributed to the rise of remote service provision. Instead of purchasing equipment and software for installation at the business concern's premises, many businesses now contract with service providers (SPs) that can supply the needed computing power to the business remotely across the Internet or other communications medium. In a typical scenario, the SPs purchase and house the computer equipment needed to run the various software applications to be used by the business and charge the business a monthly fee for access and use of the applications as well as for the new equipment. With such an arrangement, the business concern avoids the problem of purchasing soon to be obsolete equipment and further avoids having to provide floor space to accommodate this equipment. Furthermore, the business concern avoids the relatively large up-front expenditure of funds for the purchase of the equipment by instead paying for the services rendered by the SP on a periodic basis.

Although SPs have had success in selling service provision contracts, many have had difficulty in finding channels to sales of their services. One reason for this difficulty is that the assembly and maintenance of a direct sales force is very expensive and, if undertaken, would greatly increase the SP's cost of sales (i.e., the cost associated with successfully executing a sale). Therefore, many SPs could benefit from business relationships with established sales forces.

Due to the VARs' established customer bases and to the shrinking margins VARs receive for the sale of equipment to end-user customers, VARs are a logical choice for an SP sales force. Through such a relationship, SPs could gain an effective channel to sales without needing to create its own direct sales force. Unfortunately, it is often difficult for SPs to locate qualified VARs to sell their services. Similarly, it can be difficult for VARs to locate and form relationships with SPs. Accordingly, it can be appreciated that it would be desirable to have a system and method through which VARs and SPs could form business relationships with each other to sell service-based business solutions to end-user customers.

### SUMMARY OF THE INVENTION

The present disclosure relates to a system and method for aiding customers. In one embodiment, the method comprises the steps of prompting the customer in a problem defining process to provide information about issues relevant to its business and a problem the customer is experiencing, receiving customer responses to the prompts, automatically determining a potential solution to the customer problem based upon the customer responses, presenting a description of the potential solution to the customer for review.

In one embodiment, the system comprises means for electronically prompting the customer to provide information about issues relevant to its business and a problem the customer is experiencing, means for electronically receiving customer responses to the prompts, means for automatically determining a potential solution to the customer problem based upon the customer responses, and means for presenting a description of the potential solution to the customer.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 illustrates a system for facilitating business solution sales of the present invention.

FIG. 2 illustrates an example architecture for the system of FIG. 1.

FIG. 3 illustrates an example home page of an agent/SP web site of the system of FIG. 1.

FIG. 4 illustrates a first portion of an example register page of an agent/SP web site of the system of FIG. 1.

FIG. 5 illustrates a second portion of an example home page of an agent/SP web site of the system of FIG. 1.

FIG. 6 illustrates an example agent registration page of an agent/SP web site of the system of FIG. 1.

FIG. 7 illustrates an example registered agent home page of an agent/SP web site of the system of FIG. 1.

FIG. 8 illustrates an example leads page of an agent/SP web site of the system of FIG. 1.

FIG. 9 illustrates an example new lead page of an agent/SP web site of the system of FIG. 1.

FIG. 10 illustrates an example search page of an agent/SP web site of the system of FIG. 1.

FIG. 11 illustrates an example search results page of an agent/SP web site of the system of FIG. 1.

FIG. 12 illustrates an example resource library page of an agent/SP web site of the system of FIG. 1.

FIG. 13 illustrates an example registered service provider page of an agent/SP web site of the system of FIG. 1.

FIG. 14 illustrates an example profile page of an agent/SP web site of the system of FIG. 1.

FIG. 15 illustrates an example home page of a customer web site of the system of FIG. 1.

FIG. 16 illustrates an example portfolio page of a customer web site of the system of FIG. 1.

FIG. 17 illustrates an example solution discovery page of a customer web site of the system of FIG. 1.

FIG. 18 illustrates an example define a problem page of a customer web site of the system of FIG. 1.

FIG. 19 illustrates an example clarifying questions page of a customer web site of the system of FIG. 1.

FIG. 20 illustrates an example vendor profile page of a customer web site of the system of FIG. 1.

FIG. 21 illustrates an example common features page of a customer web site of the system of FIG. 1.

FIG. 22 illustrates an example problem definitions results page of a customer web site of the system of FIG. 1.

FIG. 23 illustrates an example solution showcase page of a customer web site of the system of FIG. 1.

FIG. 24 illustrates an example solutions comparisons page of a customer web site of the system of FIG. 1.

FIG. 25 is a flow diagram illustrating a first method of facilitating business solution sales of the present invention.

FIG. 26 is a flow diagram illustrating a second method of facilitating business solution sales of the present invention.

FIG. 27 is a flow diagram illustrating a third method of facilitating business solution sales of the present invention.

FIG. 28 is a flow diagram illustrating a fourth method of facilitating business solution sales of the present invention.

### DETAILED DESCRIPTION

Introduction

In view of the aforementioned problems associated with VARs and SPs in making sales, it has been determined that it would be beneficial to have a system and method in which business relationships could be facilitated between VARs and SPs that would enable both the VARs and SPs to more effectively reach and service customers. With such a system and method, VARs would be able to avoid the obsolescence problem as well as derive revenue from a sale on an on-going basis as per the service agreement between the SP and the customer (i.e., an amortized benefit). Accordingly, the VAR could continue to generate revenue from past sales while focusing on making new sales and generating further revenue. In addition to benefiting the VARs, SPs would also benefit from such relationships. For instance, SPs would have access to effective channels to sales through the utilization of the VAR's services and would further benefit from any relationships between the VAR and the VAR's established customer base.

It further has been determined that in designing such a system and method it would be beneficial to also provide means for end-user customers to familiarize themselves with the services available from the SPs as well as to make contact with the SPs through their agents. Such means both provide these customers with a way to solve their business problems and further create another effective channel to sales for the SP. Accordingly, it has been determined that a system and method in which VARs, SPs, and customers can interact with each other to form mutually beneficial relationships would be desirable. A business model is proposed herein in which VARs, SPs, and customers each derive benefit. Although the present invention is directed toward facilitating relationships between VARs and SPs, it will be understood from the discussion that follows that the VARs in these relationships act in the capacity of an agent of the SP. Accordingly, the term “agent” is sometimes used in the present disclosure in lieu of the term “VAR.” Moreover, although the term “agent” is used to designate VARs, it is to be appreciated that these agents do not necessarily need to be VARs. Therefore, as used herein, the term “agent” is an inclusive term that designates any individual or entity that works or wishes to work in an agent capacity for one or more SPs.

System Configuration

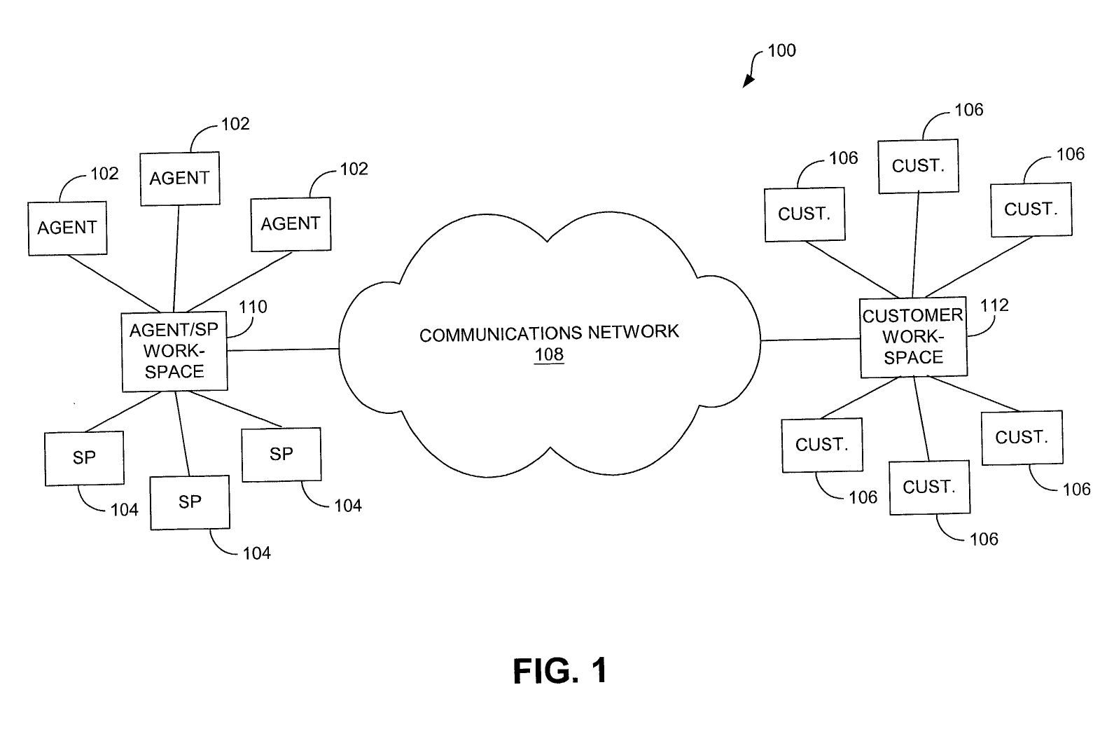

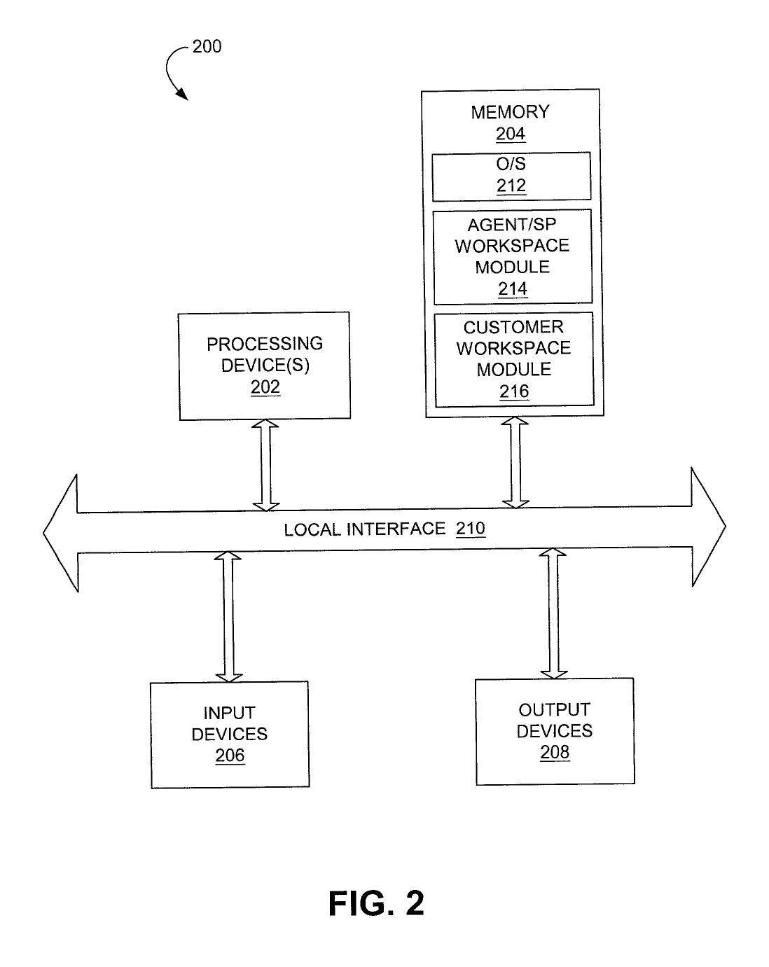

FIG. 1 schematically illustrates a system 100 for facilitating business solution sales of the present invention. As illustrated in this figure, agents 102, SPs 104, and customers 106 are each connected to a centralized communications network 108. This communications network 108 normally includes the Internet and the various infrastructure over which it operates. Although the Internet is presently preferred, it will be understood that alternative communications networks, and combinations thereof, could be used. For instance, communications could be facilitated via telephone and/or direct mailings. Accordingly, emphasis is not placed upon the nature of the communications network 108, but instead upon the system and method which it facilitates. As is further identified in FIG. 1, the agents 102 and SPs 104 can interact via an agent/SP workspace 110 of the system 100 that, via the communications network 108, is linked to a customer workspace 112 that various potential and established customers may access. As is explained below, preferred for these workspaces 110 and 112 are an agent/SP web site and a customer web site, respectively, that are accessible on the Internet and, more particularly, over the WorldWide Web.

Where the workspaces 110 and 112 comprise web sites, the system 100 can include a computing device, such as a web server, that is maintained by the system host and that operates the web sites. FIG. 2 shows the architecture of an example computing device 200 suitable for this purpose. As indicated in this figure, the computing device 200 normally includes one or more processing devices 202, memory 204, input devices 206, output devices 208, and a local interface 210 with which all the host components are in communication. By way of example, the processing device(s) 202 can comprise one or more computer processor units (CPUs) of one or more web servers. The memory 204 normally comprises random access memory (RAM) as well as storage memory (e.g., one or more hard disks or other storage media) that, at least temporarily, store data within the computing device 200. The input devices 206 typically comprise conventional user interface devices such a keyboard, mouse, and like with which a user (e.g., a system administrator) can operate and control the system 100. In addition, these input devices 206 normally include conventional interface elements through which data can be received by the system host from a system user (i.e., an agent, SP, or customer). Similarly, the output devices 208 normally include conventional interface elements through which data can be transmitted from the system host to a system user (i.e., agent, SP, or customer).

The memory 204 typically stores data conventionally held in computer memory including an operating system (O/S) 212. In addition, the memory 204 also stores the necessary commands for maintenance and control of an agent/SP module 214 and a customer module 216. These modules preferably comprise software/firmware for the generation and maintenance of the agent/SP and customer workspaces 110 and 112. Where the agent/SP and customer modules 214 and 216 are implemented in software stored in computer memory, it will be understood that the modules can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Web-Based System

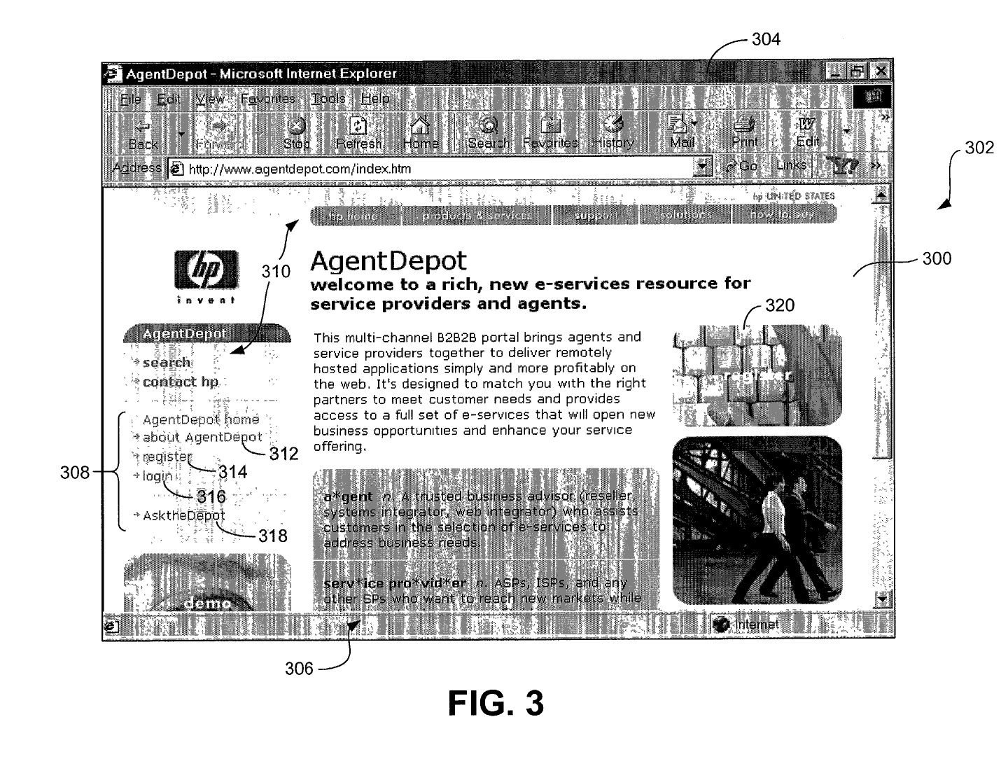

With the system 100 described above, VARs and SPs can be brought together to form business relationships such that the VAR can act as sales agent for the SP and sell the SP's business solutions to end-user customers. As identified above, the preferred vehicle for facilitating these business relationships is a web site operating over the WorldWide Web. FIG. 3 illustrates a home page 300 of an example agent/SP web site 302 with which VARs and SPs can form relationships and conduct business. In this example, the agent/SP web site is entitled AgentDepot™. The web site 302 is designated herein as an agent/SP web site in that the entities doing business with the SP, normally a VAR, will act as an agent for the SP. It is again noted, however, that the agent can comprise an individual or entity other than a VAR. By way of example, the agent/SP web site 302 can comprise a plurality of web pages that can be viewed either sequentially or in a random order. As indicated in FIG. 3, the home page 302 can be accessed via a browser 304 such as Microsoft Internet Explorer®. It is to be understood, however, that other Internet browser programs could be used to access the web site 302, such as Netscape Navigator™.

The web site home page 300 provides an introduction to the agent/SP web site 302 for users to become familiar with the system 100. In terms of the agent/SP web site 302, the “user” is a potential or established agent or SP. The home page 300 normally includes various information about the system 100 in both textual and graphical forms. By way of example, the home page 300 can include definitions 306 as to common aspects of the system 100 that explain the roles of the agent and SP in the business relationship. In addition to this information, the home page 300 can also provide a group of system-specific links 308 to other web pages of the agent/SP web site 302. Moreover, general links 310 can be provided to other web sites or pages that are in some way associated with the system host. In this example, the system host is Hewlett Packard Company (HP). Therefore, the general links 310 can include links to an HP search engine, an HP contact page, HP products page, and the like.

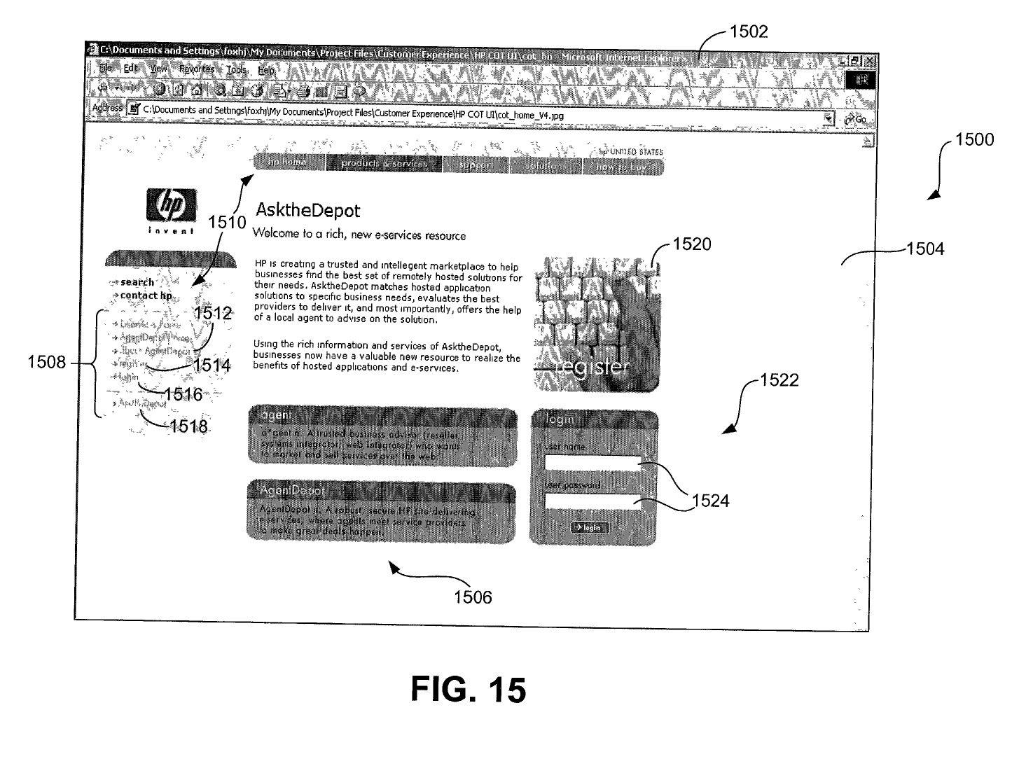

By way of example, the system-specific links 308 can include an “about AgentDepot” link 312 that can deliver the user to more information about the nature and operation of system 100 and the agent/SP web site 302, a “register” link 314 that can deliver the user to one or more registration web pages of the web site with which an agent or SP can register with the system, and a “login” link 316 that can deliver the user to a login page used to enter the system. Furthermore, the links 306 can include an “AsktheDepot” link 318 that can deliver the user from the agent/SP web site 100 to a customer web site described in greater detail below in relation to FIGS. 15-24.

If after familiarizing itself with the structure of the system 100 the potential agent or SP wishes to participate in the system, the potential agent or SP can register with the system by selecting the register link 314. As with many existing web sites, the agent/SP web site 302 can include multiple paths to a particular destination web page. Accordingly, registration can optionally be initiated by selecting another link such as a “register” button 320.

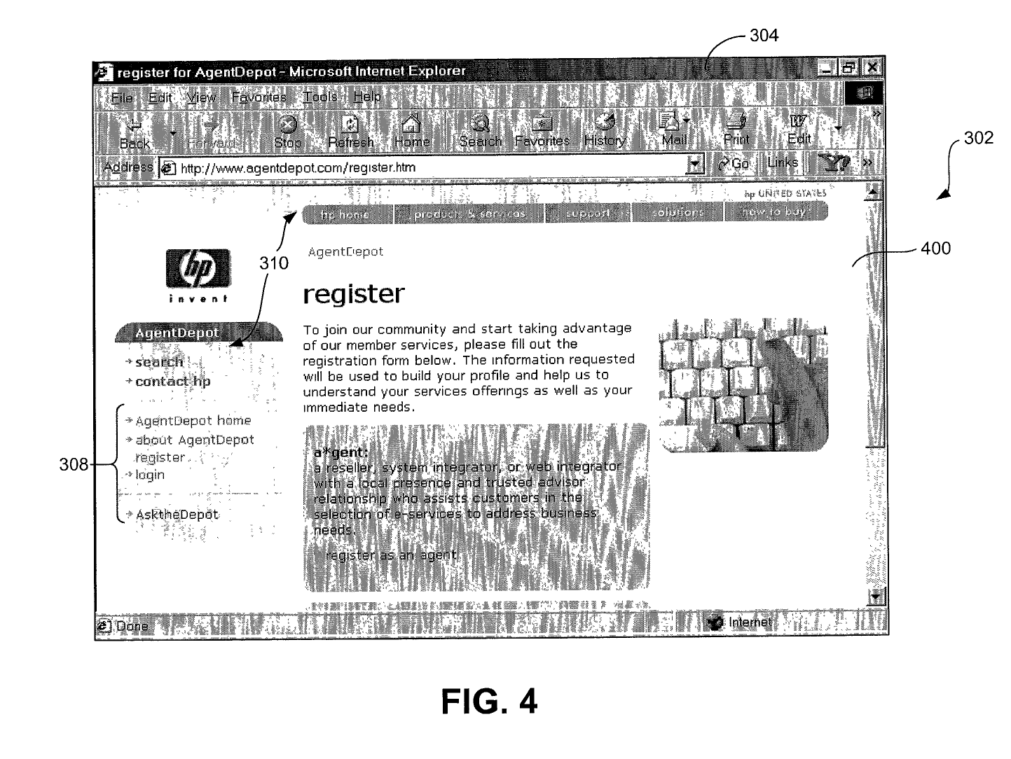

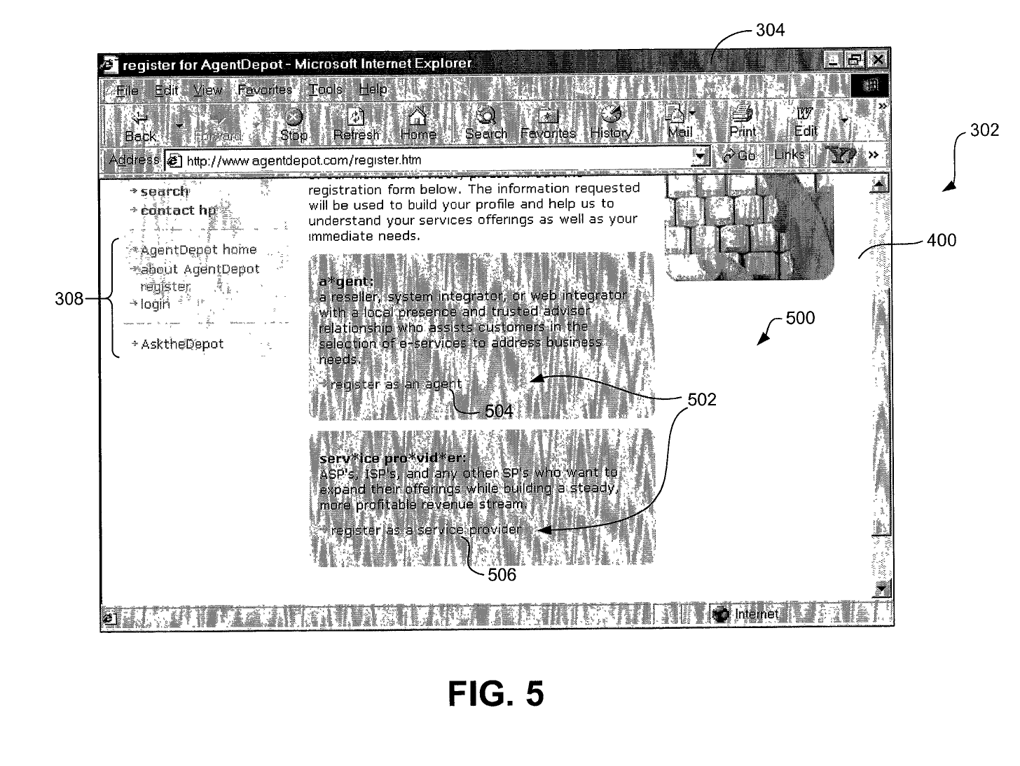

FIG. 4 illustrates an example “register” page 400 that can be accessed by an individual or entity that wishes to register as an agent. As is evident from this figure, the register page 400 (many other pages of the site 302) includes many of the features of the home page 300 shown in FIG. 3 including such system-specific links 308 and general links 310. In the interest of brevity, the present disclosure will not redescribe the function of such reappearing features and instead will focus on the features most pertinent to the inventive system and method. Accordingly, not every feature and/or link presented in the figures is discussed. In that the entire register page 400 is not visible in FIG. 4, FIG. 5 is provided to show the remainder of the register page 400 and facilitate description of the system 100. As indicated in FIG. 5, the register page 400, like the home page 302, includes definitions 500 for both “agent” and “service provider.” In addition, however, provided are links 502 that can deliver the user to the registration pages used to register as an agent or as an SP. By way of example, shown in FIG. 5 is a “register as an agent” link 504 and a “register as a service provider” link 506.

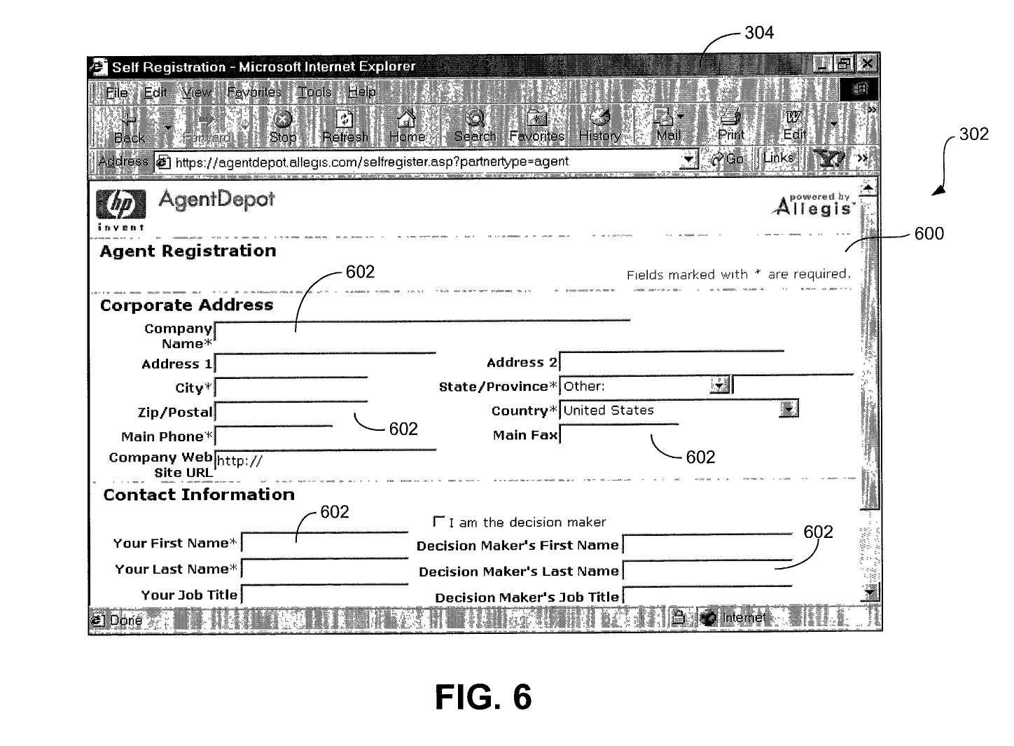

If the user would like to register as an agent, the user selects the register as an agent link 504 and is delivered to an agent registration page 600 shown in FIG. 6. In that the registration process may require the input of a relatively large amount of information, several web pages can be provided to receive the relevant agent information. As indicated in FIG. 6, the agent registration page 600 comprises a plurality of information fields 602 that are adapted to receive information concerning the agent and the agent's business. As will be appreciated by persons having ordinary skill in the art, the various information collected through the agent registration page 600 may vary depending upon what information is deemed most relevant to registering the user as an agent. In that the user is to be associated with an SP, the most relevant information may be that which the SPs registered with the system 100 consider important in making the decision as to whether to use the user as an agent. Normally, however, this information will include information about the agent's company and location, the agent's contact information, and information as to the nature of the agent's business in terms of company size, geographic locations, areas of practice, and the like. In addition, more substantive information can be requested, for instance, information as to which hardware products the agent currently offers, which software products the agent currently offers, which services the agent currently offers, what consulting services the agent provides, what environments in which the agent has operated, which industries the agent has targeted, and so forth. By collecting this information, the registered SPs will be able to learn much about the agent and its experience prior to extending an agency position to the agent.

With reference back to FIG. 5, an SP can register with the system 100 in similar manner by selecting the register as a service provider link 506 so as to be delivered to an SP registration page (not shown) similar to the agent registration page 600 shown in FIG. 6. The SP registration page typically also includes a plurality of information fields that are adapted to receive information input by the SP about its business. Relevant information again may include the company name and location, contact information, and information as to the nature of the SP's business. Relevant inquiries as to the SP's business may include, for instance, the type of services the SP offers, the markets the SP targets, the hosted solutions currently offered by the SP, the hardware platforms currently used by the SP, the operating system platforms currently used by the SP, and so forth.

Once the user, whether it be an agent or SP, has registered in the manner described above, the user can access various web pages of the agent/SP web site 302 that are not accessible to unregistered users. With these web pages, the user, particularly registered agents, can use the system 100 as a virtual work space in which to conduct its business. Access is normally gained by the registered user by accessing a login page (not shown). By way of example, and with reference back to FIG. 3, the login page can be accessed by selecting the “login” link 316. Once having logged in, e.g., by entering a username and a password, the user can access the various registered user web pages. Typically, the nature and content of these web pages depends upon whether the user is a registered agent or a registered SP. Various examples of these pages are discussed below. It is stressed that these pages are described only for the purpose of explanation. Persons having ordinary skill in the art will appreciate that these pages could take many different forms and are subject to change over time. The pages particular to registered agents are discussed first, followed by a discussion of the pages particular to registered SPs.

Registered Agent Participation

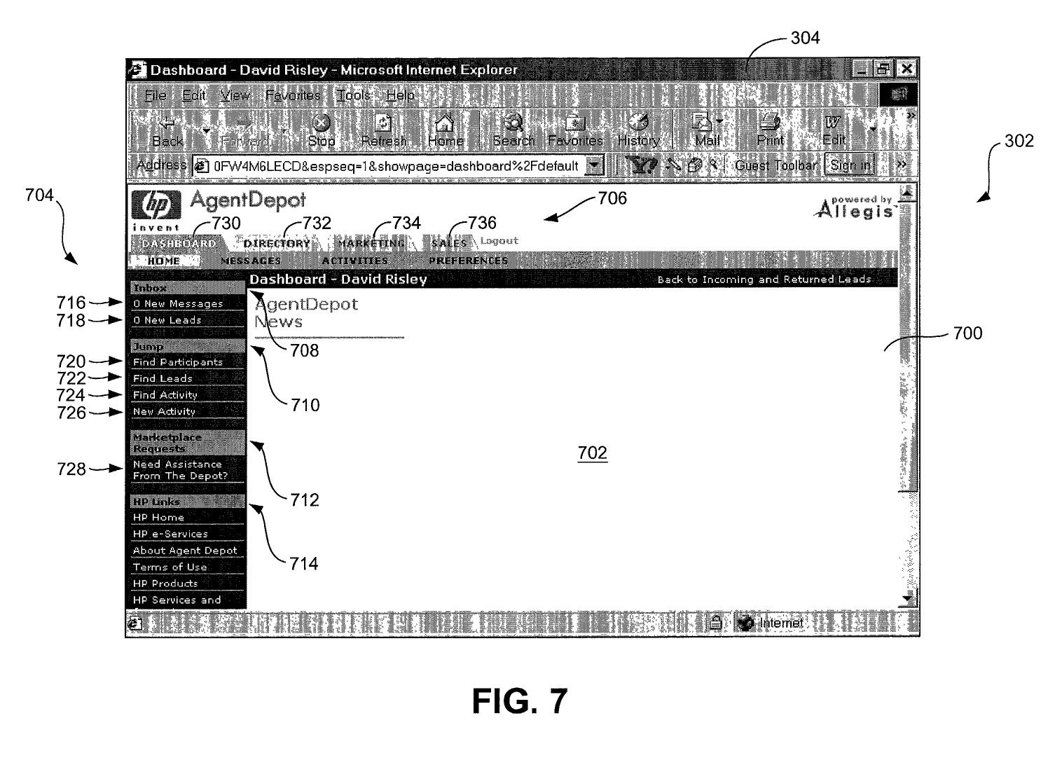

As the following discussion will elucidate, a registered agent of the inventive system 100 can use the agent/SP web site 302 to receive information relevant to its business, make contact with SPs with which it would like to associate, receive leads to customers interested in making a business solution purchase, as well as organize and manage its business. Normally, the first page the agent views once logged into the system 100 is a personalized home page. FIG. 7 illustrates a registered agent home page 700 accessible through the agent/SP web site 302. As indicated in FIG. 7, the home page 700 generally comprises an information window 702, designated as the “Dashboard” in FIG. 7, in which various information can be displayed to the registered agent. Normally, news-oriented information that may be useful to the agent is provided in the window 702. By way of example, the information window 702 can be used to display information as to new SPs that have joined the system 100, new services available from existing and/or new SPs, etc. Normally, this information is presented in “bullet” form with each bullet including a link that, when selected, delivers the agent to another page containing the relevant information in textual and/or graphical form. Accordingly, the information window 702 functions as a “whiteboard” for information that a registered agent may be interested in knowing.

In addition to the information window 702, the registered agent home page 700 can include a plurality of links 704 as well as a plurality of tabs 706. As shown in FIG. 7, the links 702 can be divided into categories such as an “Inbox” category 708, a “Jump” category 710, a “Marketplace Requests” category 712, and an “HP Links” category 714. The tabs 706 of the registered agent home page 700 can include a “Dashboard” tab 730, a “Directory” tab 732, a “Marketing Tab” 734, and a “Sales” tab 736, each of which is described below in the discussion of the various registered agent pages.

As indicated in FIG. 7, the HP Links category 714 can comprise a plurality of links to various general web sites and/or pages of the system host, in this example Hewlett-Packard Company. The Inbox category 708 can include a “New Messages” link 716 and a “New Leads” link 718. When the New Messages link 716 is selected, the agent is delivered to an electronic mail inbox page (not shown) that permits the agent to compose and read electronic mail messages directed to and received from other registered users (typically agents) of the system 100.

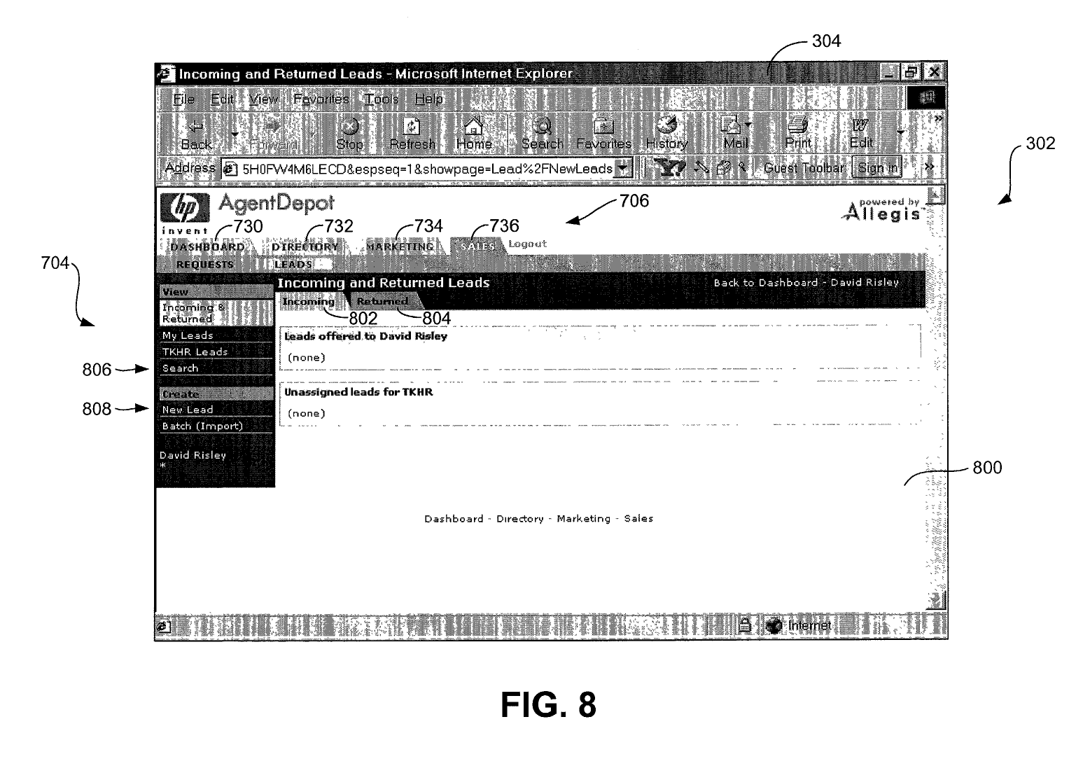

When the registered agent selects the New Leads link 718, the agent is delivered to a leads page 800 shown in FIG. 8. As indicated in this figure, the leads page 800 is visible when the Sales tab 736 is highlighted. The leads page 800 includes an “Incoming” leads tab 802 as well as a “Returned” leads tab 804. When the Incoming leads tab 802 is highlighted (as it is in FIG. 8), the leads that have been offered to the particular registered agent will be visible. As is discussed below, these leads can be sales leads that have been directed to the particular agent from an employer or leads that have been directed to the agent by the system 100 based upon a customer inquiry. As indicated in FIG. 8, the leads can be divided into those provided to the individual agent specifically and those that have been obtained by the agent's employer but have not yet been assigned to an agent. When the Returned leads tab 804 is selected, displayed are all leads that were made available to the agent but that were withdrawn for one reason or another. By way of example, a lead can be withdrawn from an agent if the agent declines the lead or fails to act upon the lead within a predetermined duration of time. Typically, all leads displayed on the leads page 800 will include an active link to details about the lead such as the potential customer and the business solutions in which the potential customer may be interested.

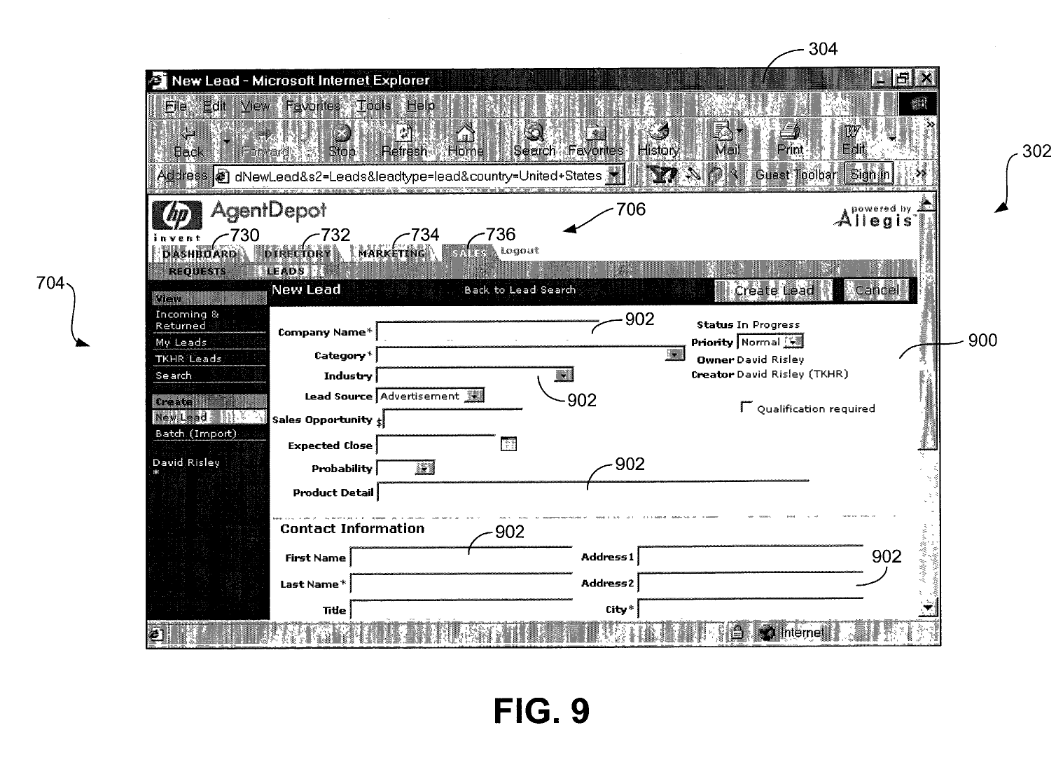

In addition to listing the leads currently available (or unavailable) to the agent, the agent can further search the leads by selecting the “Search” link 806 from the leads page 800. When selected, the agent is taken to a search engine page (not shown) in which the agent can conduct a word search through the group of leads displayed in the leads page 800. This feature can be helpful to the agent in finding a particular lead, especially where the agent (or the agent's employer if applicable), has obtained a large number of such leads. In addition to conducting a search of the leads within the leads page 800, the agent can also create its own leads by selecting the “New Lead” link 808. When selected, the New Lead link 808 transports the agent to a “New Lead” page 900 (FIG. 9) in which the agent can register the lead. By way of example, the new lead could have been generated through an existing customer with whom the agent works that has a problem that may be solvable with a business solution offered by a registered SP. As indicated in FIG. 9, the New Lead page 900, like the agent registration page 6, includes a plurality of fields 902 in which the agent can enter information relevant to the lead and the potential customer.

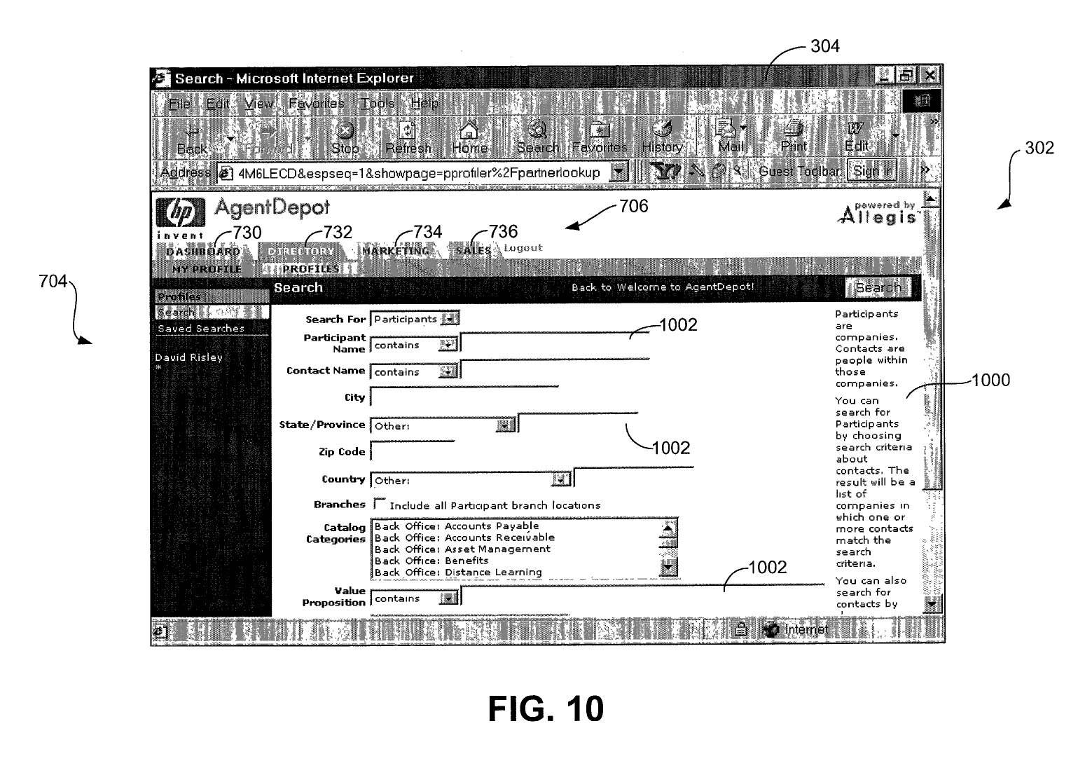

With reference back to FIG. 7 and the registered agent home page 700, the links under the Jump category 710 can include a “Find Participants” link 720, a “Find Leads” link 722, a “Find Activity” link 724, and a “New Activity” link 726. The Find Participants link 720 can be particularly useful to the registered agent. When this link 720 is selected, the agent is taken to a “Search” page 1000 shown in FIG. 10 and the Directory tab 732 is highlighted. The Search page 1000 comprises a plurality of fields 1002 in which the agent can enter information relevant to a particular SP or to a particular problem to which the agent would like to find a solution. For instance, the agent can enter pertinent information about a known registered SP such as a company name, contact name, geographic location, etc. to locate a particular SP that the agent believes to have a solution that may serve a potential or established customer of the agent. Where the agent does not already know of an SP that has an appropriate solution, the agent can alternatively enter information about the problem being experienced by the customer in hopes of locating a registered SP that has a viable solution. Accordingly, the Find Participants feature of the we site 302 provides the agent with a convenient and efficient way of finding a solution for a particular customer problem, as well as finding an SP that can provide the solution.

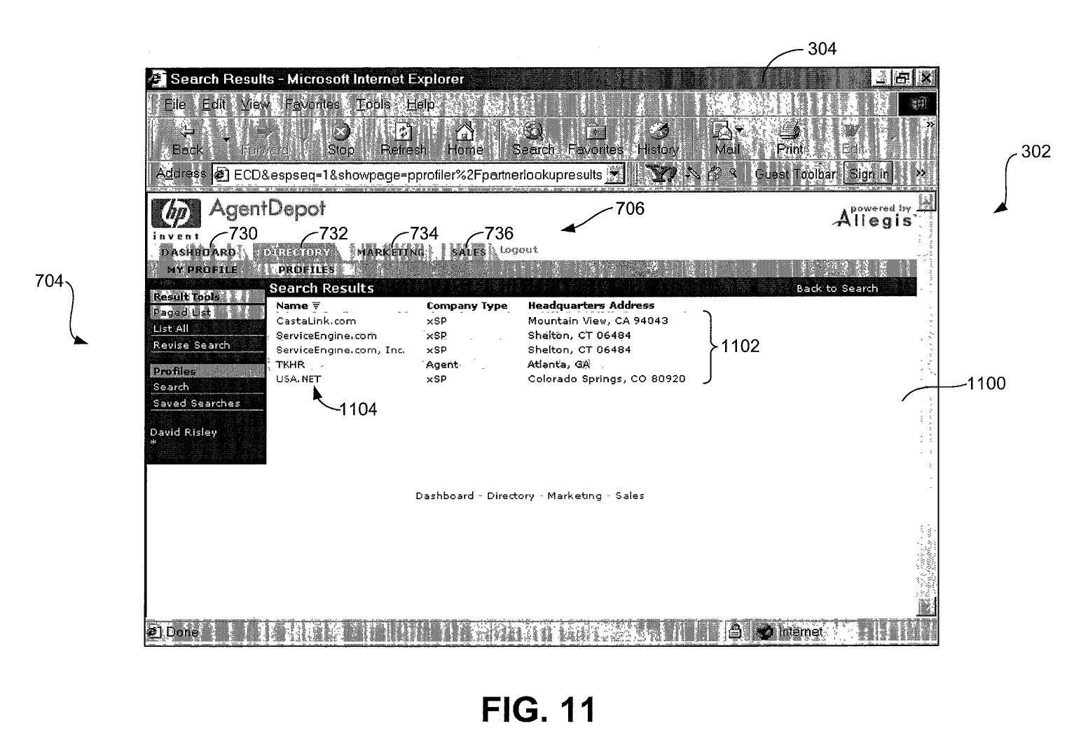

Once all relevant information has been entered by the agent into the Search page 1000, the agent is normally presented with a Search Results page 1100 shown in FIG. 11. As indicated in this figure, the Search Results page 1100 displays a plurality of entries 1102 that satisfy the search criteria entered by the agent. Typically, each of the entries 1102 includes an active link 1104 to detailed information about a particular SP and information as to the business solutions the SP offers through the system 100. After having located a solution and an appropriate SP, the agent can then take steps to make contact with the SP to, if it has not already, become authorized as an sales agent for that SP and the particular solution that the agent would like to sell to the customer. This process is described in greater detail below.

Returning again to FIG. 7, the next example link of the Jump category 710 is the Find Leads link 720. When this link 720 is selected by the agent, the agent is taken to find leads page (not shown) described above in relation to the New Lead page 900. Accordingly, when accessed, this page can be used to conduct a search of all leads displayed to the user through the New Lead page 900. Moving on to other links under the Jump category 710, the Find Activity link 724 can be used to search through various activities that have been assigned to the agent. The “activity” as used herein to designate a task that the system 100 (e.g., a system administrator) can assign to the agent and track to ensure that the task has been completed. By way of example, such an activity can comprise completing training required by a particular SP for which the agent would like to work. The agent can optionally be provided with automatic electronic reminders to complete the activity by the system to aid the agent with keeping pace with its obligations.

With further reference to FIG. 7, the agent can also create and assign activities for the system or another agent by selecting the New Activity link 726 under the Jump category 710. By way of example, the agent could request the system 100 to obtain certain information from a particular registered SP. In another example, a new activity can be assigned by a manager of an agency to a particular registered agent directing the agent to perform a customer call, etc.

Referring now to the Marketplace Requests category 712 in FIG. 7, the agent can select the “Need Assistance From the Depot” link 728 to make contact with and request help from the system 100. When selected, the agent is presented with a contact page (not shown) having features similar to a conventional electronic mail page with which the agent can direct inquiries to a system administrator. For instance, if the agent has a customer with a problem that the agent believes can be solved by a particular solution offered by a registered SP, the agent could communicate this information to the system administrator and request information as to what training and/or qualifications are required by the SP to act in an agent capacity for the SP.

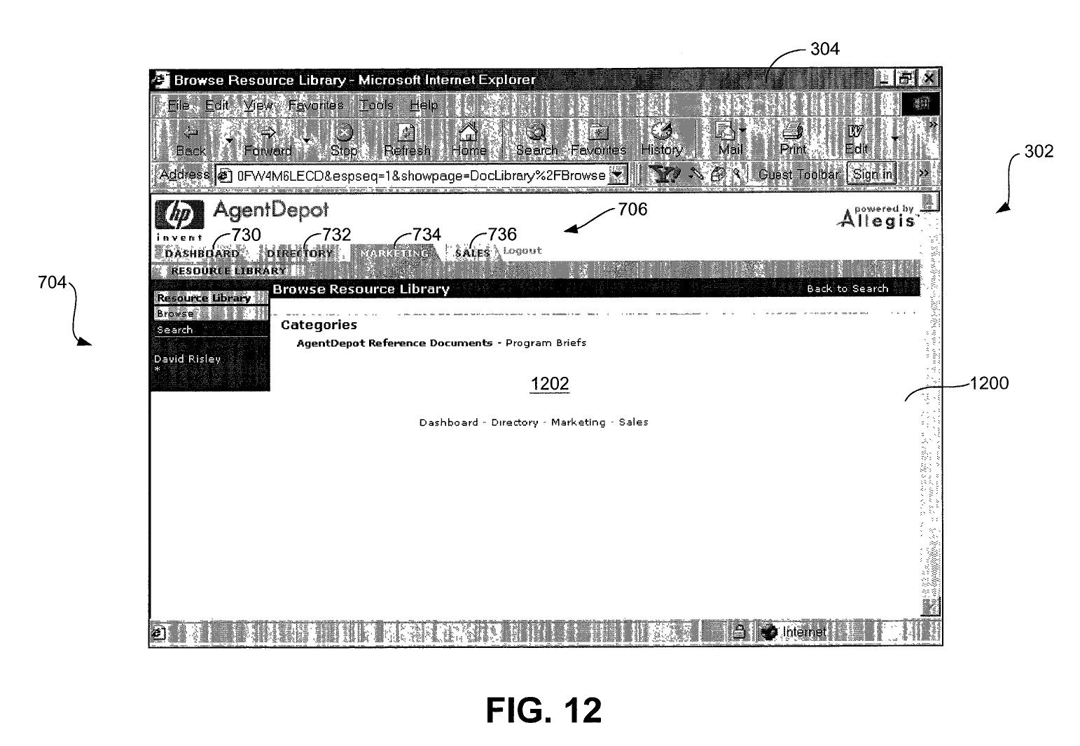

With reference to FIG. 12, much of the information concerning registered SPs can be obtained from the “Resource Library” page 1200 accessible through selection of the “Marketing” tab 734. As with the home page 700, this page 1200 includes an information window 1202 that display headlines and provide active links to information concerning the various SPs that participate in the system 100. In addition to containing or providing access to general information about the SPs and their business solutions, the Resource Library page 1200 can provide the agent with information about the training and/or qualification requirements specified by each SP for each offered business solution. In a preferred embodiment, such training and/or qualification is facilitated by the system 100. In such an embodiment, the required training information can be communicated to the agent in a “webcast” or “on-demand” format via the agent/SP web site 302. In a webcast scenario, one or several agents interested in particular training can log into to a virtual class being taught by a remote instructor. In the on-demand scenario, the agent can call up tutorial information for instance comprising text, video, audio, etc., which provides the training necessary for acting as an agent for a particular SP. In addition to such training, the system 100 can facilitate qualification of the agent, if necessary. For instance, if an SP requires an agent to pass a particular test prior to qualifying as an agent of the SP, the agent/SP web site 302 can be used to administer the test online. Although online training and/or qualification via the agent/SP web site 302 is described herein, it is to be understood that non-online training/qualification can be used in lieu of or in conjunction with the online training/qualification. Where training/qualification is facilitated online via the agent/SP web site 302, the information window 1202 can further be used to schedule such training/qualification, e.g., with training and/or testing calendars.

From the above discussion, it can be appreciated that the agent/SP web site 302 is a valuable tool with which an agent can generate and conduct business is described in the next section, SPs can also use the agent/SP web site 302 to their advantage.

Registered SP Participation

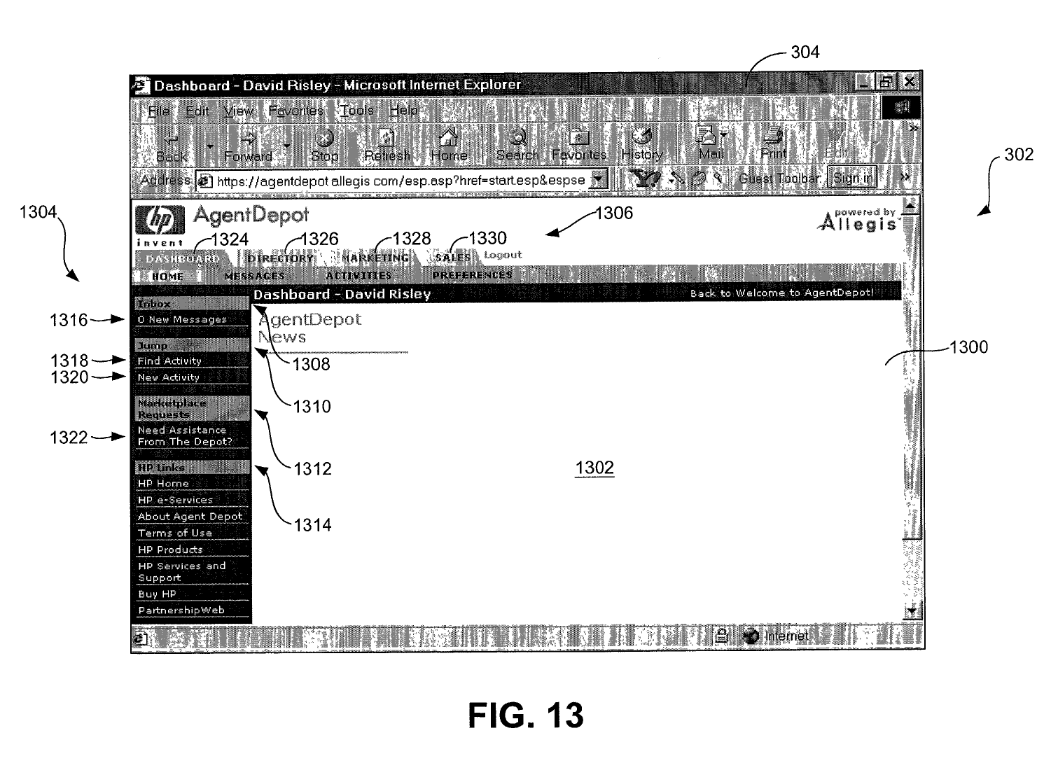

As with the registered agent side of the agent/SP web site 302 described above, the first page displayed to an SP after logging into the system 100 is a personalized home page. FIG. 13 illustrates a registered SP home page 1300 that is accessible through the agent/SP web site 302. As indicated in this figure, the home page 1300 generally comprises an information window 1302 that, like the information window 702 on the agent side, is designated as the “Dashboard.” In this window, various information can be displayed to the registered SP. Again, news-oriented information can be provided in the window 1302. By way of example, the information displayed in the window 1302 can be the same as that shown to registered agents in the registered agent's information window 702. Alternatively or in addition, the window 1302 can be used to display other information particularly useful to the SP such as information as to new agents that have registered with the system 100. Again, the various entries can include links that, when selected, deliver the SP to other pages containing the relevant information.

As with the registered agent home page 700, the registered SP home page 1300 can include a plurality of links 1304 as well as a plurality of tabs 1306 with which the SP can navigate the web site 302. The links 1302 can similarly be divided into categories such as an “Inbox” category 1308, a “Jump” category 1310, a “Marketplace Requests” category 1312, and an “HP Links” category 1314. Similarly, the tabs 1306 of the registered SP home page 1300 can include a “Dashboard” tab 1324, a “Directory” tab 1326, a “Marketing Tab” 1328, and a “Sales” tab 1330. The HP Links category 1314 typically comprises a plurality of links to various general web sites and/or pages of the system host, in this example Hewlett-Packard Company. The Inbox category 1308 can include a “New Messages” link 1316 that is used in similar manner to the likenamed link described above in relation to the registered agent home page 700.

With continued reference to FIG. 13 and the registered SP home page 1300, the links 1304 under the Jump category 1310 can include a “Find Activity” link 1318 that is used in similar manner to that described above in reference to the registered agent home page 700. In addition, provided is a “New Activity” link 1320. By way of example, this link 1320 can be used to create an activity that is assigned to a system administrator. For instance, the SP could request the system 100 to provide the SP with certain information about a particular registered agent with whom the SP may be interested in working. In another example, a new activity can be assigned by a manager of a the SP to a particular registered representative employed by the SP, etc.

Referring now to the Marketplace Requests category 1312, the SP can select the “Need Assistance From the Depot” link 1322 to make contact with and request help from the system 100. As in the registered agent context, the SP is presented with a contact page (not shown) having features similar to those of conventional electronic mail applications with which the SP can compose and receive communications transmitted to and received from a system administrator. By way of example, contact with one or more agents can be initiated with aid from a system administrator.

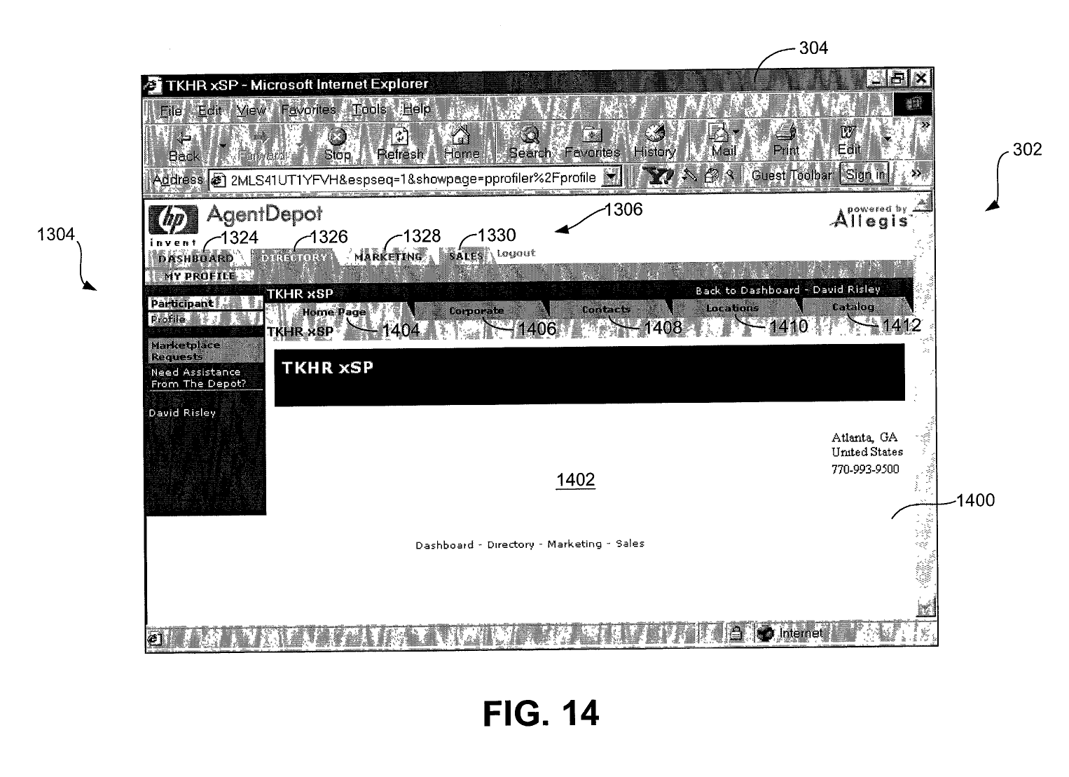

Of the various tabs 1306 available to the SP, perhaps most significant is the Directory tab 1202, which delivers the SP to an SP profile page 1400. At the profile page 1400, the SP can review its profile that is made available to all agents registered with the system 100. As shown in FIG. 14, this information can be divided into a plurality of categories such as a “Home Page” category 1404, a “Corporate” category 1406, a “Contacts” category 1408, a “Locations” category 1410, and a “Catalog” category 1412. By way of example, the Home Page category 1404 can contain general information about the SP such as the general types of solutions it offers and the general types of customers it normally services. The Corporate category 1406 can include detailed information about the corporate structure of the SP including the size of the company, its yearly revenues, and the like. The Contacts category 1408 can include detailed information about the individuals that are employed by the SP and their contact information such as telephone numbers, email addresses, and so forth. The Locations category 1410 can identify the various number and geographic location of each branch of the SP. Finally, the Catalog category can contain the details about the various business solutions that the SP offers and which are available for agents of the SP to sell to end-user customers.

Once all information the SP wishes to convey has been entered in the various categories of the profile, this information can be shared with the various registered agents of via the system 100. Normally, this information is accessible to the agents through the Search page 1000 of the agent side of the web site 302 shown in FIG. 10. In addition, the information contained in the SP profile can be used as a basis for news posted to the information window 702 of the registered agents' home pages 300. As conditions change, the SP can update the information contained in the SP profile by accessing the profile page 1400 and making the necessary listing changes.

From the above discussion, it can be appreciated that the agent/SP web site 302 is also a valuable tool with which an SP can generate interest in its business solutions and attract agents to obtain a effective channel to sales. Therefore, from the SP perspective, the agent/SP site provides a channel to sales as well as marketing venue.

Customer Participation

As noted above, it is desirable not only to facilitate the business relationships between agents and SPs, but it is also desirable to incorporate a new customer base into the system 100 to give the agents and SPs opportunities for new sales, as well as provide effective business solutions to customers in need of them. In that the agent/SP web site 302 described above is focused on agents and SPs and the formation of relationships therebetween, a separate web site focused on customer needs has been envisioned. An example customer web site 1500 is illustrated in FIGS. 15-24. As with the agent/SP web site 302, this customer web site 1500 can be accessed via the Internet by using a conventional Internet browser 1502. As indicated in FIG. 15, the customer web site 1500 of this example is entitled “AsktheDepot”. As with the agent/SP web site 302, the customer web site 1500 can comprise a plurality of web pages including a home page 1504 that is shown in FIG. 15. This home page 1504 includes various information about the system 100 in textual and graphical form and further, like the agent/SP web site home page 302, can provide definitions 1506 as to various aspects of the system. In addition, the customer web site home page 1504 can include a variety of system-specific links 1508 as well as general links 1510 associated with the various web sites and/or pages supported by the system host.

As with the home page 300 of the agent/SP web site 302, the system-specific links can include an “about” link 1512, a “register” link 1514, and a “login” link 1516. The about link 1512 provides the customer with further detail about the system 100 and how it can be used to the customer's advantage. If the customer is interested in joining the system 100, the customer can select the register link 1514 and be directed to a registration page (not shown) similar in nature to the registration pages described above in relation to registration of agents and SPs. Accordingly, the customer can input information about its business and the contact information of various individuals employed by the customer. Alternatively or in addition, the home page 1504 can include a separate “register” button 1520 that can deliver the customer to the appropriate registration page. Notably, the customer can register one or more individuals with the system 100. Accordingly, the customer can form a buying team that has the responsibility for locating viable solutions to the customer's problems.

Once registered with the system 100, the customer can login to the system by selecting the login link 1516. This link 1516 normally directs the user to a login page (not shown) at which the customer can enter a usernane and a password to gain access to the remainder of the web site 1500. Alternatively, or in addition, the home page 1504 can include a “login” box 1522 that contains fields 1524 for entry of the username and password. When provided, the login box 1522 expedites the login process. In addition to these links, an agent/SP web site link 1518 can be provided to permit the customer to visit the agent/SP web site 302 described above. Unless the customer wishes to register as an agent and/or SP, the customer will not have access to the pages of the agent/SP web site that are only accessible by logging into the system 100.

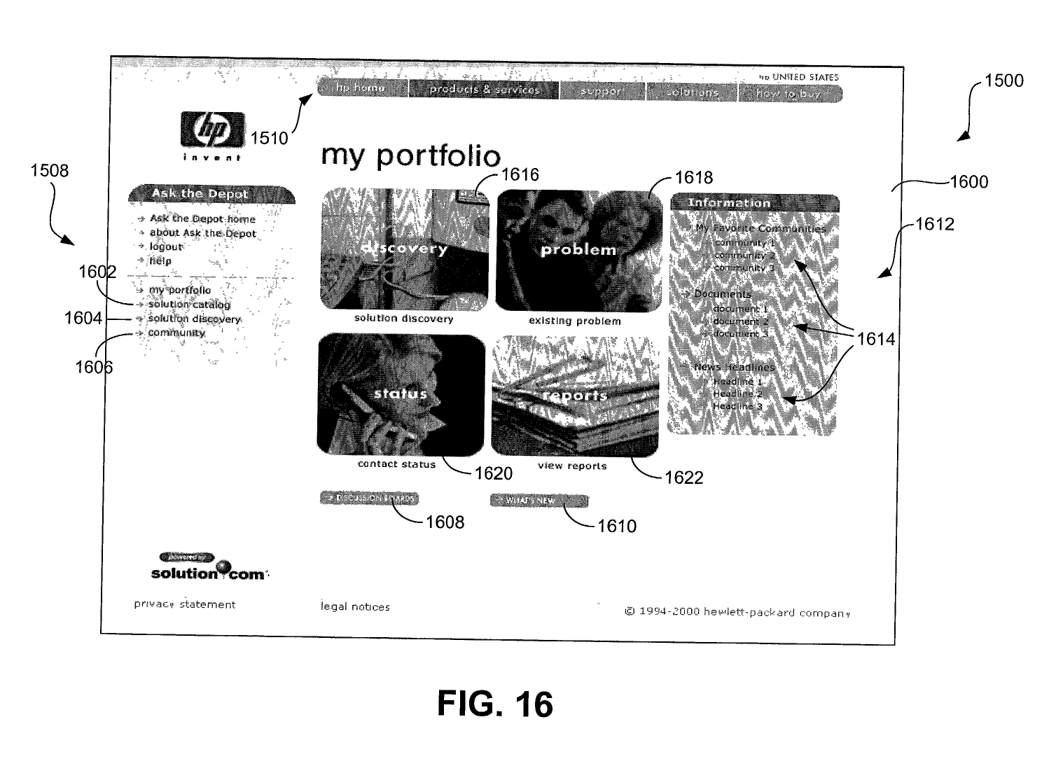

After having logged into the system 100, the customer is taken to a portfolio page 1600 illustrated in FIG. 16. It is noted that FIGS. 16-24 illustrate example web pages without an associated web browser. It will be understood, however, that these pages can be accessed over the Internet with a suitable web browser such as those identified above. The portfolio page 1600 is a desktop that can be used by the customer to gain information about business solutions that are available. As with the other pages described above, the portfolio page 1600 can include a plurality of system specific links 1508. Of particular interest are the “solution catalog” link 1602, the “solution discovery” link 1604, and the “community” link 1606. The solution catalog link 1602 delivers the customer to detailed information about all of the solutions offered by the SPs that have registered with the system 100. Accordingly, if the customer already has an idea of what solution is needed, it can access this information through the solution catalog link to peruse the available solutions. If a desired solution is located, the customer can then request a qualified agent to contact the customer, as is discussed in greater detail below. In the more typical situation in which the customer does not already know what solution is best, the customer can select the solution discovery link 1604 that initiates a problem defining process. As discussed below, this process can be used to define the customer's problem/need and help it locate an appropriate solution.

The community link 1606 can be used to interact with other customers that have registered with the system 100. For instance, the community link 1606 can deliver the customer to a community page (not shown) in which the customer can view discussion boards, participate in chat rooms, and generally obtain information from other customers and learn from their experiences. In addition to this link the portfolio page 1600 can include a “discussion boards” button 1608 that provides the customer with direct access to the discussion boards. Further information can be obtained by the customer by selecting the “what's new” button 1610 that, when selected, provides the user with up-to-date information that may be relevant to the customer's business. In addition to these links, the portfolio page 1600 can further include an “Information” box 1612 that contains various links 1614 to information that may be useful to the customer. For instance, the links 1614 can be used to directly access the customer's favorite customer communities, various documents relevant to the customer's business, and important news headlines.

In that the customer may not be familiar with the various types of business solutions available and to which problems they are applied, the customer may need help in defining its business problems to aid it in determining what solutions may be appropriate. Accordingly, the customer web site 1500 is adapted to help the customer define its business problems. Because many of the problems experienced by customers are the same, the process of defining the problems lends itself to automation. In particular, by receiving certain pieces of information about the problems, it is possible to electrically generate a probable definition of the problems and narrow down a set of possible solutions from the catalog of solutions offered by the system. Through such a method, a customer can determine the type of business solution it may need before communicating with an SP agent.

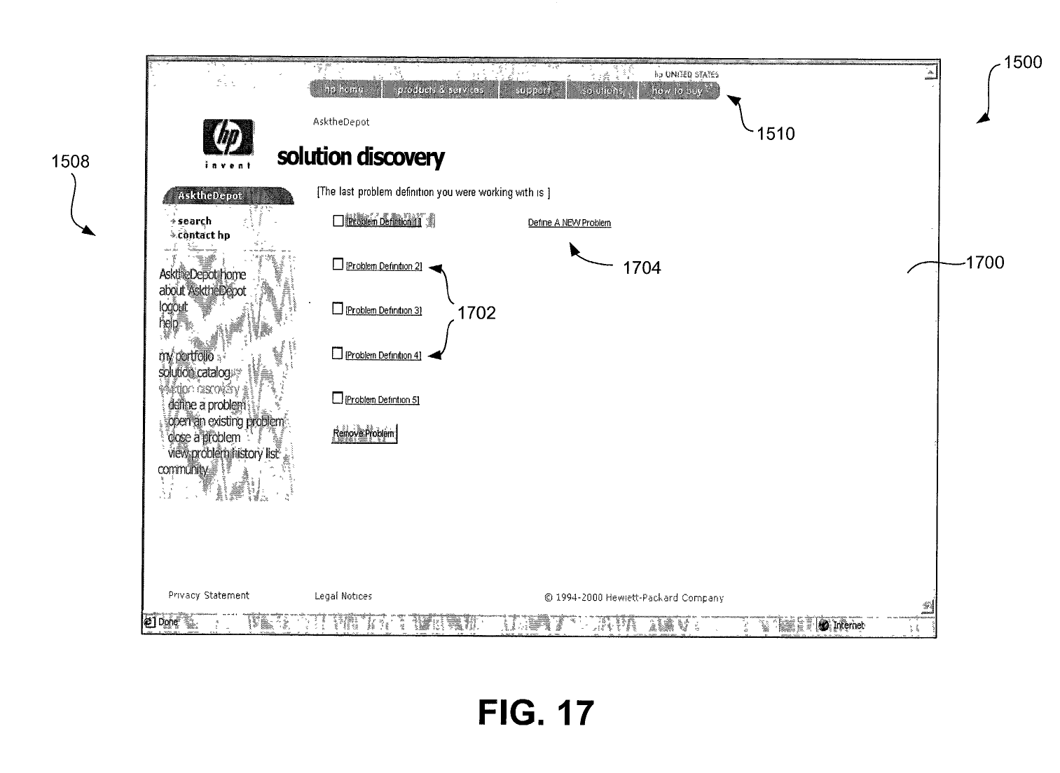

The portfolio page 1600 can include a variety of buttons with which the customer can navigate the various web pages that can be used by the customer to define its problem/need and find its solution. By way of example, the page 1600 can include a “discovery” button 1616, a “problem” button 1618, a “status” button 1620, and a “reports” button 1622. When selected, the discovery button 1616 presents the customer with a “solution discovery” page 1700 shown in FIG. 17. As indicated in the figure, the solution discovery page 1700 can include a list of individual problem entries 1702 that were created in a previous session by the customer. Accordingly, after the problem definition process described below has been completed or at least initiated, the problem can be stored by the system 100 and listed for the customer on the solution discovery page 1700. Normally, each problem entry 1702 comprises a link to another page or pages that detail the information entered by the customer as to the particular problem. Accordingly, where the customer has several distinct problems, each can be evaluated with the aid of the system 100 and revisited later, if desired.

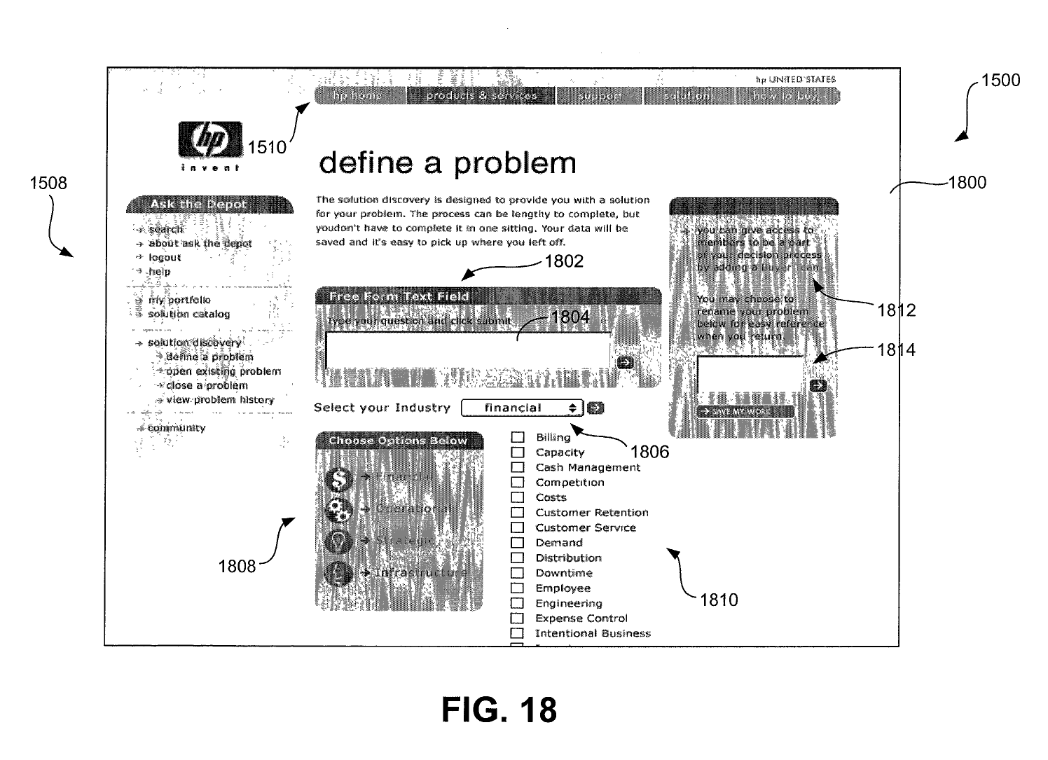

In addition to listing previously defined problems, the solution discovery page 1700 can include a “Define a NEW Problem” link 1704. When this link 1704 is selected, the customer can be brought to a “define a problem” page 1800 illustrated in FIG. 18. As will be appreciated from the discussion that follows, the define a problem page 1800 constitutes the first of several web pages that the customer can use to detail various aspects of the problem on which further information is needed. As indicated in FIG. 18, the define a problem page 1800 can include a question box 1802 in which the customer can pose a question as to a particular problem that is being experienced. For instance, the question can be written in a text field 1804 formed within the question box 1802. The system 100 can receive this question and automatically evaluate it using conventional word recognition algorithms to narrow the search for a definition and possible solution for the problem.

In addition to the question box 1802, the define a problem page 1800 can include a menu 1806 of possible industries in which the customer operates. For instance, as shown in FIG. 18, the “financial” industry is indicated. With this selection, the system 100 will further narrow the search for possible problem/solution combinations. Furthermore, the field of problem/solution sets can be narrowed by selecting various areas of concern in an options box 1808. As shown in the example of FIG. 18, the areas of concern can comprise “Financial”, “Operational”, “Strategic”, and “Infrastructure.” When a particular area of concern is selected by the customer, various check boxes 1810 appear adjacent the options box 1808 that are relevant to that particular area of concern that is selected. For instance, where the Financial area of concern has been selected, the check boxes 1810 pertain to various issues that fall within the financial domain. Accordingly, where the problem involves, for instance, billings and costs, the customer can select these issues by checking the appropriate boxes.

In addition to the aforementioned tools provided in the define a problem page 1800, the page can further include a “Buyer Team” link 1812 that, when selected, permits the customer to form its own buying team composed of all or some of the individuals registered with the system and employed by the customer. By creating such a team, each team member can go through the problem defining process and access others' team members' problem definition efforts for purposes of comparison and/or information sharing. In addition, the define a problem page 1800 can include a field 1814 for entry of a file name under which the session can be saved if the customer wishes to discontinue the process and return to it later. When saved in this manner, the problem typically will appear as an entry 1702 in the solution discovery page 1700.

Once one or more of the tools described above have been used by the customer, the customer can proceed to the “clarifying questions” page 1900 at which further information as to the problem being experienced by the customer is entered. As indicated in this figure, the clarifying questions page 1900 can include a questions box 1902 in which focused questions pertaining to previously entered information (e.g., entered in the define a problem page 1800) can be answered. By way of example, each of the questions can be provided in bullet form with question text 1904 and associated check boxes 1906. In addition to the questions box 1902, the clarifying questions page 1900 can include an “Information” box 1908 in which the customer can obtain information as to various topics related to the responses the customer has input up to this point. By way of example, these topics can be listed next to check boxes 1910 that can be selected by the customer to expand the search for problem solutions. In addition, the Information box 1908 can include a notepad field 1912 in which the customer can jot down notes that will be saved with the problem defining session.

The clarifying questions page 1900 can also include an “Active Education” box 1914 that contains links 1916 to various information concerning topics germane to the information that has been entered by the customer up until that point in the problem defining process. Furthermore, the clarifying questions page 1900 can include a solution counter box 1918 that keeps track of the number of solutions identified by the system 100 based upon the information entered by the customer thus far. Normally, many different solutions will be identified by the solution counter 1918 at this early stage of the problem defining process. If, however, the customer would like to check these solutions at this point, the customer can select the “View Solutions” button 1920 to bypass the remainder of the problem defining process and view the solutions identified by the system 100. Notably, when this option is exercised, the customer can return to the clarifying questions page 1900 (or other pages for that matter) and continue to narrow the problem and thereby the potential solution set.

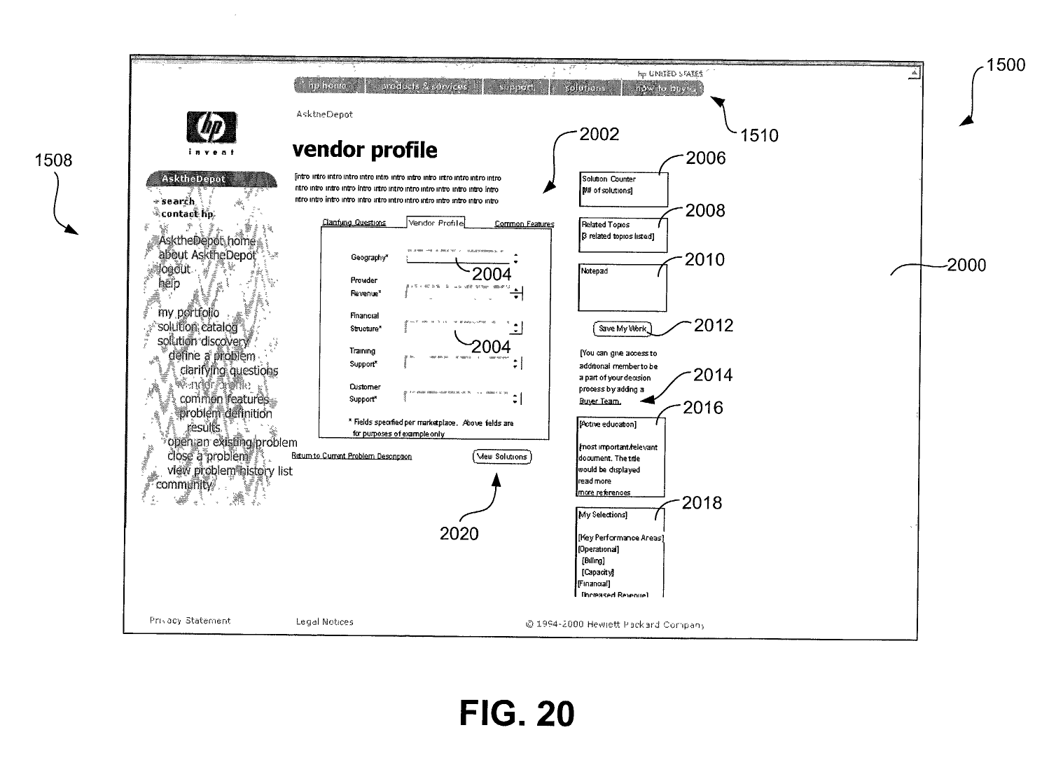

Once the customer has completed the clarifying questions page 1900, the customer can turn to the “vendor profile” page 2000 shown in FIG. 20. At this page 2000, the customer can specify the type of vendor, i.e., SP, with which it may like to receive a business solution. Accordingly, the vendor profile page 2000 normally includes a vendor profile box 2002 that contains a plurality of fields 2004 through which the customer can indicate preferences such as the geographical location of the SP, revenues range for the SP, financial structure of the SP, and the like. In addition to the vendor profile box 2002, the vendor profile page 2000 can includes several features found in other pages described above. For instance, the vendor profile page 2000 can include a session counter 2006, an Information box 2008, a notepad field 2010, a save button 2012, a Buyer Team link 2014, an Active Education box 2016, and a View Solutions button 2020. Furthermore, the vendor profile page 2000 can include a “My Selections” box 2018 through which the customer can review the responses input into the system 100 up to this point.

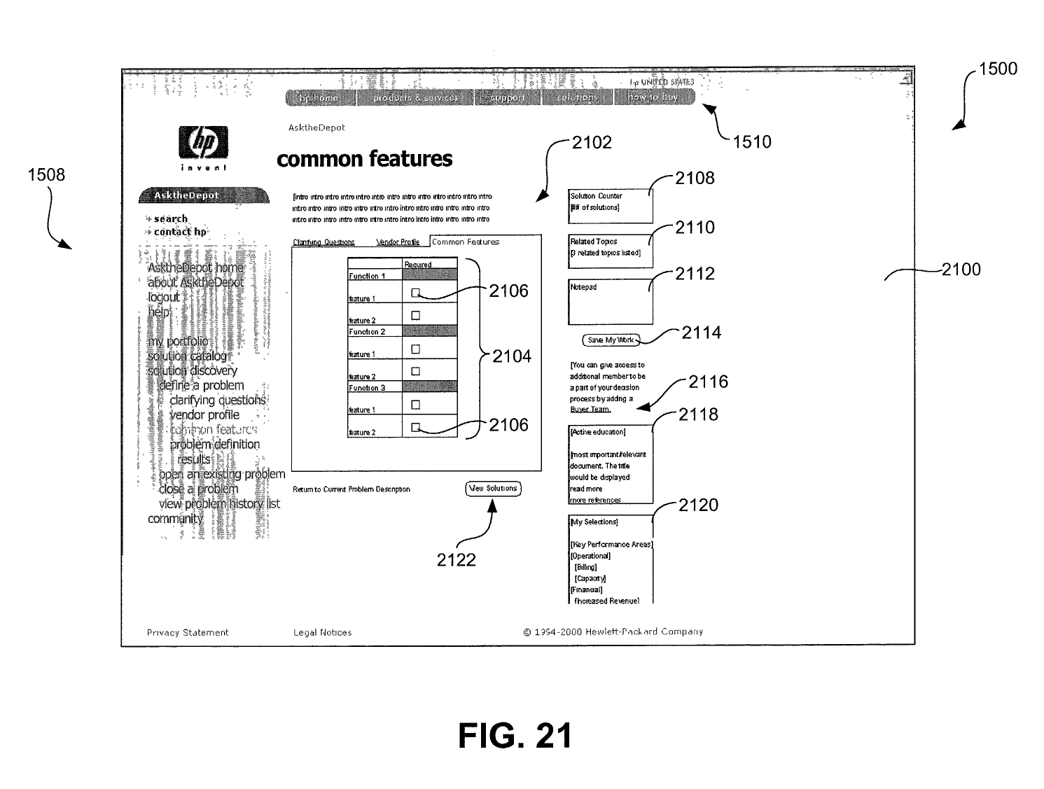

After completing the vendor profile page 2000, the customer can move on to the last page normally used to define the customer's problem, the “common features” page 2100 illustrated in FIG. 21. At this page 2000, the customer's search can be narrowed by reviewing common features generated by the system 100 based upon the customer's responses in previous pages and selecting those that appear most relevant to the customer's problem. By way of example, these selections can be made in a “Common Features” box 2102 that presents the common features in a list 2014. These features can be selected by checking check boxes 2016 associated with particular features. As with the vendor profile page 2000, the common features page 2100 can contain a session counter 2108, an Information box 2110, a notepad field 2112, a save button 2114, a Buyer Team link 2116, an Active Education box 2118, a My Selections box 2120, and a View Solutions button 2122.

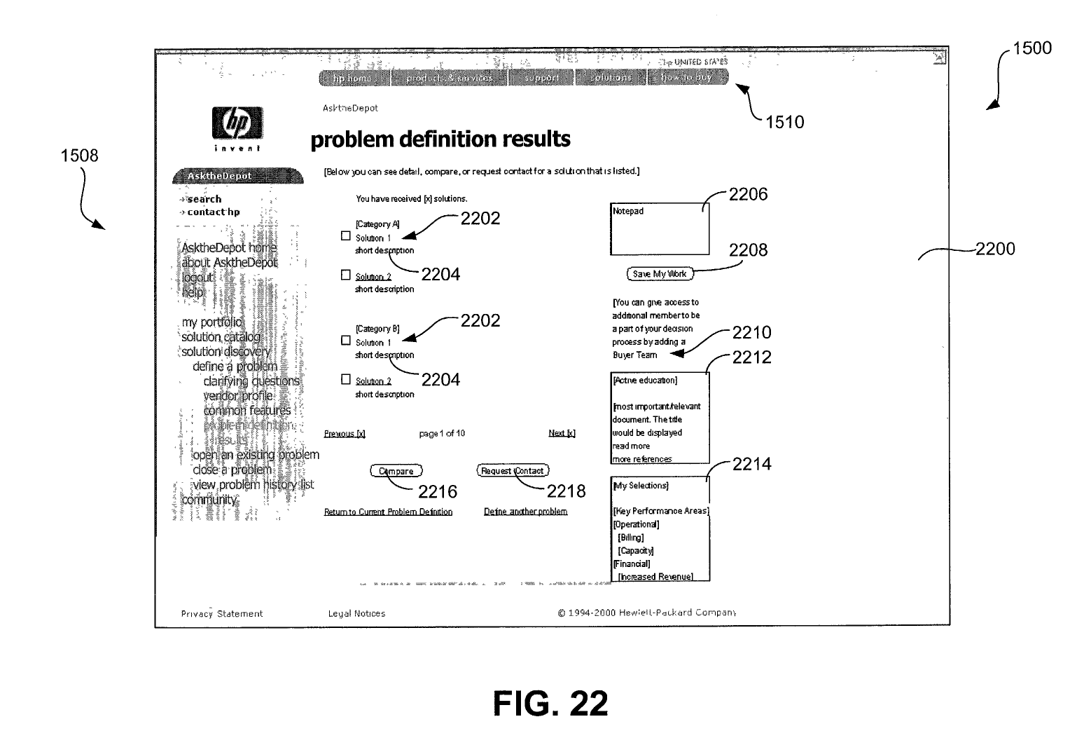

Once the common features page 2100 has been completed (or if the customer at any time selects a View Solutions button), the customer can be presented with results that define the problem or problems faced by the customer and possible solutions to this or these problem(s). FIG. 22 illustrates an example “problem definition results” page 2200. As indicated in this figure, the results can be displayed to the customer in list form under various categories 2202. These categories 2202 can comprise separate problems identified by the system 100 or, alternatively, subproblems or subissues associated with an overall problem. Normally, each problem solution is provided in the form of a bullet 2204 that typically includes a link that can be used to obtain more information about the problem solution. In addition to listing possible problem solutions, the problem definition results page 2200 can include common features such as a notepad field 2206, a save button 2208, a Buyer Team link 2210, an Active Education box 2212, and a My Selections box 2214. However, the problem definition results page 2200 typically further includes a “Compare” button 2216 and a “Request Contact” button 2218, the purpose and finctioning each being provided below.

The customer can review the list 2014 of potential solutions and can select them one-by-one for perusal. When the customer selects a particular solution, the customer can be taken to a “solution showcase” page 2300, which provides the details of the proposed solution and information about the SP that offers it. By way of example, this information can be conveyed to the customer with an information window 2302. Typically, the information is presented to the user in conjunction with a plurality of “Value Proposition” links 2318 that can be selected to control the information shown to the customer in the information window 2302. For instance, with these links 2318, the customer can choose to view information as to the solution details, company data, third party information, etc.

If, after reviewing these details, the customer would like to speak with an agent of the SP providing the potentially viable solution, the customer can select the “Request Contact” button 2304 provided on the solution showcase page 2300. As identified above, a similar button is also available from the problem definition results page 2200. Once the Request Contact button 2304 is selected, the system 100 (e.g., a system administrator) makes arrangements for an authorized agent (normally in the customer's geographic area) to contact the customer directly to discuss the nature and cost of the proposed solution. By way of example, the agent can be notified of the customer's interest by delivering a lead to the agent's leads page 800 shown in FIG. 8. If, on the other hand, the user is not interested in the particular solution, the customer can return to the list of solutions provided in the problem definition results page 2200 by selecting the “Back to List of Results” button 2306. As with several other pages of the web site 1600, the solution showcase page 2300 can include a notepad field 2308, a save button 2310, a Buyer Team link 2312, an Active Education box 2314, and a My Selections box 2316.

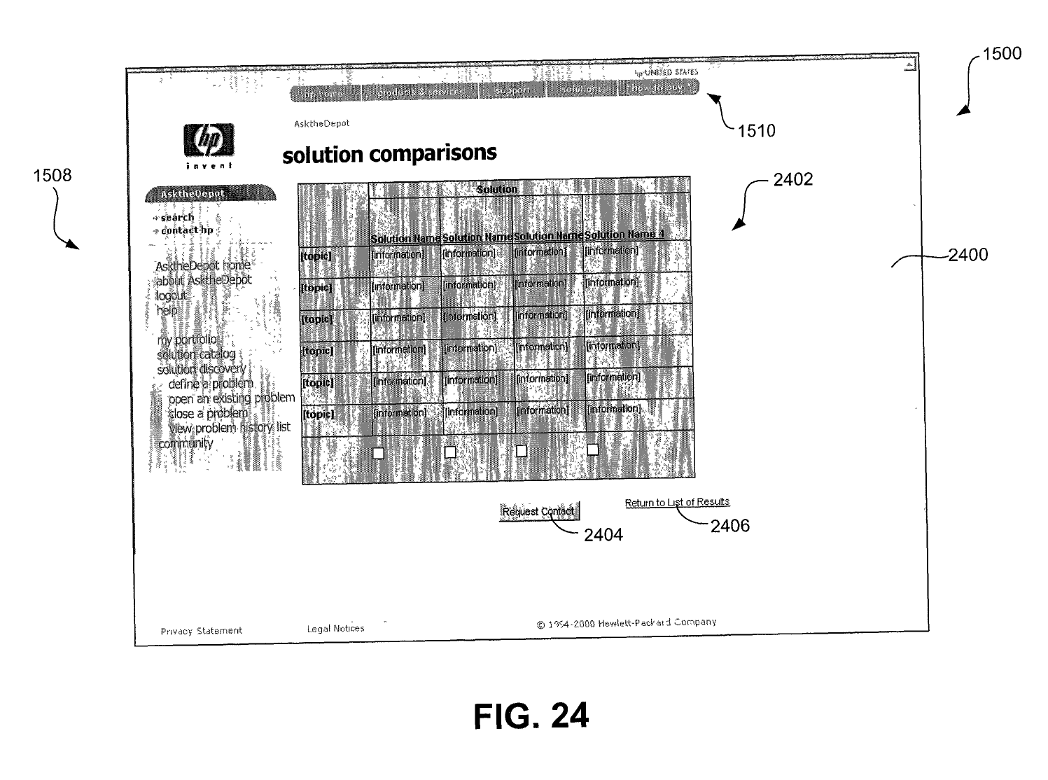

With reference back to the problem definition results page 2200, the customer can compare and contrast the various solutions identified by the system 100 by selecting the Compare button 2216. Selection of this button 2216 delivers the customer to the “solution comparisons” page 2400 shown in FIG. 24. As indicated in this figure, the features of the solutions can be presented in a chart 2402 that crosses these features with various issues and/or topics. Arranged in this manner, the chart 2402 can be used by the customer to directly compare the solutions and select the solution that appears to best solve the customer's problem. The solutions comparisons page 2400 can also include a “Request Contact” button 2404 and a “Return to List of Results” page 2406.

System Operation and Methods of Use

The example system 100 described above can be used by agents, SPs, and customers alike to form business relationships that serve their needs. In that the operation of the system 100 can perhaps best be understood by examination of illustrations of its use, illustrations of such use will now be provided. It is to be understood that these exemplary are only examples and that alternative methods of using the system 100 can be practiced. To simplify the description of how the system 100 is used, system use is discussed from the perspectives of the various participants of the system, i.e., the agents, SPs, and customers.

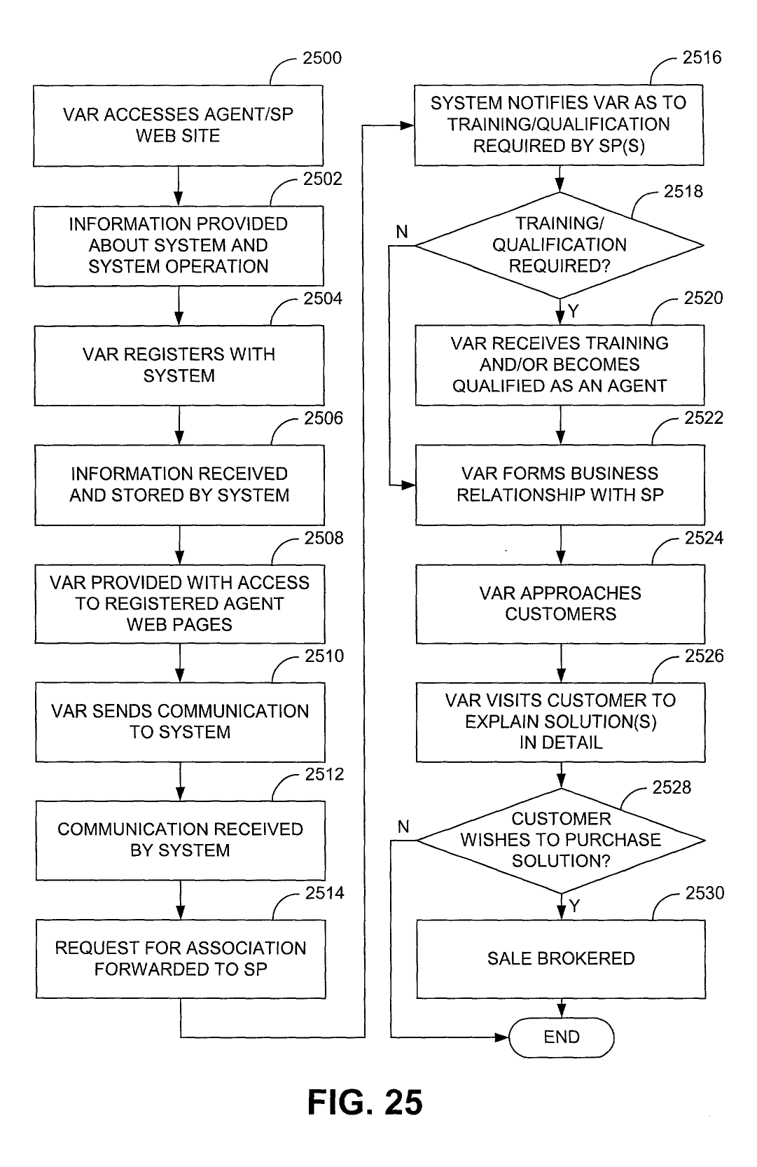

Beginning with the agents, the system 100 can be used to gain access to new “products,” or more particularly services, that the agent can offer to customers. In that sale of these services does not involve the problems discussed above associated with equipment sales, the agent can achieve attractive margins for the agent's sales. Moreover, the agent can derive an ongoing monetary benefit stemming from the periodic payments made by the customer. Referring to FIG. 25, a first agent scenario is examined. In this scenario, the agent comprises a VAR having an, at least partially, established customer base that wishes to begin selling business solutions of the type offered by SPs. As indicated in block 2500, the VAR gains access to the agent/SP web site 302 described in detail above. As mentioned above, the VAR may comprise a single individual reseller or a company employing several such individuals. At this web site, information is provided to the VAR about the system 100 and its operation, as indicated in block 2502. Through the provision of this information, the VAR can also learn about the SPs currently participating in the system 100 and what business solutions these SPs offer.

If, after reviewing this information, the VAR is interested in joining the system 100, the VAR can register with the system 100, as indicated in block 2504. Normally, by registering, the VAR enters into an agreement with the system host as to various terms of their relationship. For instance, the agreement may specify the nature of the relationship, compensation arrangement, and the like. As described above, registration is accomplished by the VAR by entering various information about the VAR and its business. As this information is entered by the VAR, it is received and stored by the system 100, as indicated in block 2506. Where the VAR is a company employing several persons that are to act in the capacity of agents, each agent can register individually in this manner. Once the information has been stored by the system 100, the VAR can be provided access to the registered agent web pages described above, as indicated in block 2508. Normally, this access is extended to the VAR via a username and associated password. Through registration, the VAR can then navigate the various pages to learn detailed information about the participating SPs and their offered services, receive leads for potential sales, receive news relevant to the VAR's business, communicate with associate agents working for the VAR, etc. Accordingly, the agent/SP web site 302 can be used by the VAR as a virtual workspace in which it can conduct its business.

Through interaction with the agent/SP web site 302, the VAR can determine the SPs with which it would like to do business. Once having made this determination, the VAR can send a communication to the system 100, as indicated in block 2510, and more particularly a system administrator, identifying the VAR's interest in doing business with one or more registered SPs. As is apparent from the discussion about the system 100 provided above, this communication can be effected in various ways. For instance, the VAR can select the Need Assistance from The Depot link 708 shown in FIG. 7 to generate a text message that is sent to a system administrator requesting affiliation with the SP or SPs. Alternatively, the VAR can create an activity for the system administrator through the New Activity link 726 also shown in FIG. 7.

Irrespective of the manner in which the VAR communicates with the system 100, the system receives the communication, as indicated in block 2512, and determines what steps will be taken in response to the communication. Normally, the system 100 will forward the request to the appropriate SP or SPs, as indicated in block 2514. In addition, the system 10 can send a reply to the VAR that identifies what training and/or qualification is required by the SP or SPs to become an authorized agent, as indicated in block 215. If there is a training/qualification requirement, the system 100, e.g., through a system administrator, can, for example, assign an activity to the VAR that can be accessed by the VAR through the Find Activity link 724. By assigning such an activity, the system 100 can specify what training is to be undertaken and the various qualification procedures as well as establish a time frame for the completion of the training/qualification. Where the training and/or qualification procedures, are administered online via the agent/SP web site 302, the system 100 can further notify the VAR as to how the training is provided and how the qualification is achieved, along with a schedule of online training sessions and qualification proceedings.

If training/qualification is required, flow proceeds from decision element 2518 to block 2520 in which the VAR receives the necessary training and/or participates in qualification procedures. By way of example, the qualification procedure can comprise an online exam that tests the VAR's knowledge as to the information relevant to the products that the VAR wishes to sell. Once the VAR has received the appropriate training and qualifies as an agent, or if no training or qualification is required by the SP, the VAR forms a business relationship with the SP, as indicated in block 2522. Normally, this step involves the VAR and SP entering into a contract in which the VAR is authorized to offer one or more of the SP's business solutions to customers. By way of example, this process can be facilitated by the agent/SP web site 302 online or through the standard mail service.

At this point, the VAR may choose to approach customers to inform them that the VAR is now authorized to sell business solutions that may be useful to the customers, as indicated in block 2524. For instance, the VAR may approach some or all of its established customer base in hopes of making sales. If one or more of these customers are interested in the SP's business solutions, the VAR can visit the customer in person to explain the business solution and how it would benefit the customer, as indicated in block 2526. At this point, the customer can determine if it is interested in purchasing the solution, as indicated in decision element 2528. If so, a sale can be brokered, as indicated in block 2530. Otherwise, the flow is terminated and the VAR can approach a different customer.

As will be appreciated by persons having ordinary skill in the art, the nature and arrangement of the sales agreement, as well as the compensation for the various participants in the system, can vary. Typically, however, the system host will host the agreement and therefore receive all payments from the customer. Normally, these payments are paid one service period (e.g., one month) in advance. Each payment is distributed by the system host to the VAR and the SP according to the terms of the agreements formed between the VAR and the system host as well as the SP and the system host. By way of example, the VAR can receive a sales commission of approximately 11-12% and the SP can receive a payment of approximately 60%. Although a significant portion of the proceeds are retained by the system host, both the VAR and SP derive substantial benefit through participation in the system 100. In particular, the VAR receives the opportunity to derive income from sources other than equipment sales and the SP receives an indirect sales force having direct contact with many customers.

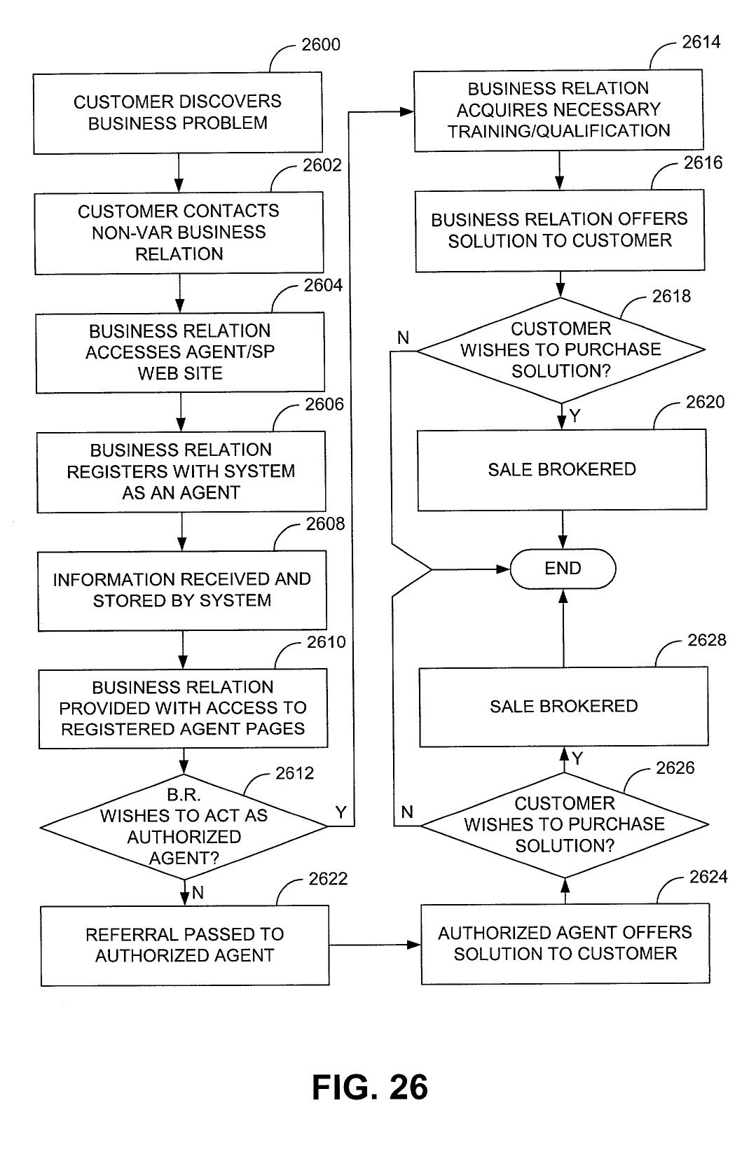

Although the scenario described above is a common one, it is by no means the only scenario in which the system 100 can be used. An alternative scenario is illustrated in FIG. 26. In this scenario, the agent is not a not a VAR, but an individual or entity having an established business relationship with a customer in a capacity other than the sale of equipment and/or software. Suppose, as indicated in block 2600, a customer has a business problem with which it needs help. For instance, assume the customer is having accounting problems. Being faced with these problems, the customer may contact a non-VAR business relation, as indicated in block 2602 for suggestions how to overcome the problem. For example, the customer may contact an accounting firm with which it has worked in the past. Although the business relation may not be in the business of selling software solutions, the firm can still act in the capacity of an agent through the system 100. For instance, if the business relation is aware of the system, it can access the agent/SP web site 302, as indicated in block 2604, to learn more about the system 100 and the solutions available through it. Notably, information can also be gleaned from the customer web-site 1500 and access later gained to the agent/SP web site 302.

If, after reviewing this information, the business relation believes that it may be able to offer a viable business solution to the customer via the system 100, it can register with the system 100, as indicated in block 2606. This registration is conducted in the same manner as that described above in relation to the VAR. Once the information has been received and stored by the system 100, as indicated in block 2608, the business relation can be provided with access to the registered agent web pages, as indicated in block 2610. The business relation can then determine whether it would like to act in the capacity of an agent for the SP offering the solution that may solve the customer's problems, as indicated in decision element 2612. If so, the business relation can then obtain the necessary training and/or qualification required by the SP offering the desired solution, as indicated in block 2614, and then offer the solution to the customer, as indicated in block 2616. The customer can then determine whether it would like to purchase the solution, as indicated in decision element 2618. If so, the sale can be brokered, as indicated in block 2520. As before, the agent, e.g., accounting firm, receives a standard commission for the sale and the SP receives the bulk of the sales proceeds.

If, on the other hand, the business relation does not wish act in the capacity of an agent of the SP, it can pass a referral to a registered agent authorized to sell the solution, as indicated in block 2622, for instance by visiting the customer's premises and explaining the solution. The authorized agent can then offer the solution to the customer, as indicated in block 2624. Again, the customer can determine whether it would like to purchase the solution, as indicated in decision element 2626. If so, the sale can be brokered, as indicated in block 2528. In this variant, the authorized agent receives the standard commission, the SP receives the bulk of the sales proceeds, and the business concern receives a referral reward (e.g., 1-2%).

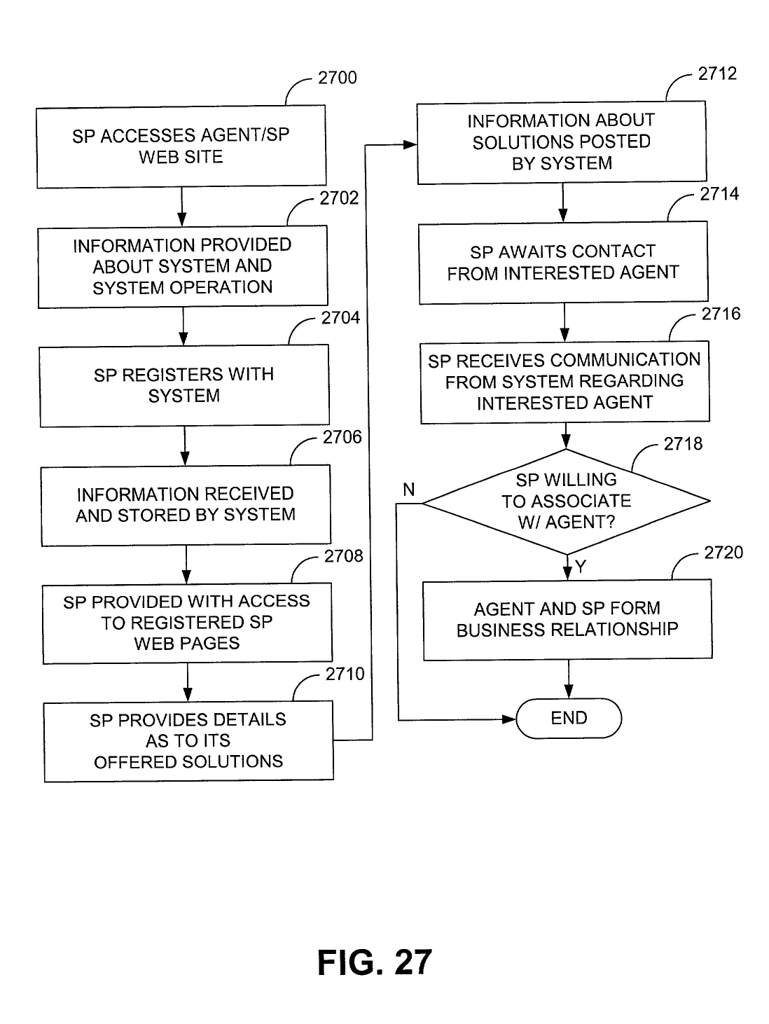

Turning to the SP's perspective, reference is made to FIG. 27. As indicated in block 2700, an SP can access to the to the agent/SP web site 302. As with the VAR scenario mentioned above, the SP may comprise a single individual or a company employing several such individuals. At the web site 302, information is provided to the SP about the system 100 and its operation, as indicated in block 2702. If the SP is interested in joining the system 100, it may register with the system 100, as indicated in block 2704. Again, registration normally includes entry of an agreement that defines the relationship between the SP and the system host. Registration is accomplished by the SP by entering various information about the SP, as well as information as to the business solutions it offers. As this information is entered by the SP, it is received and stored by the system 100, as indicated in block 2706. After the information has been stored by the system 100, the SP is provided access to the registered SP web pages described above, as indicated in block 2708. Again, this access can be extended to the SP via entry of a usemame and associated password. Once registered, the SP can provide the system 100 with detailed information as to the number and nature of its business solutions it would like to offer. In addition, the SP can specify the training and/or qualification requirements associated with each solution, as indicated in block 2712. This information can, for example, be provided to the system 100 electronically, by standard mail service, or the like. The system 100 can then post this information on the agent/SP web site 302, as indicated in block 2712. By having this information posted, the SP can provide valuable information to the various registered agents. Accordingly, this functionality provides an information sharing function as well as a marketing function for the SP.

Once the information is posted by the system, the SP can access it at any time by simply accessing the profile page 1400 illustrated in FIG. 14. From time to time, the SP can modify the information and/or add new information as conditions change. The SP can await contact from agents who wish to sell the SP's solutions 2714. As described above, the SP can be alerted to interest by agents by the system administrator, as indicated in block 2716. At this point, the SP can determine whether it does or does not wish to associate with the agent, as indicated in decision element 2718. If the SP would like to authorize the agent to sell its solutions, the agent and SP can form a business relationship as indicated in block 2720. Otherwise, flow is terminated and the SP can await contact from a different agent.

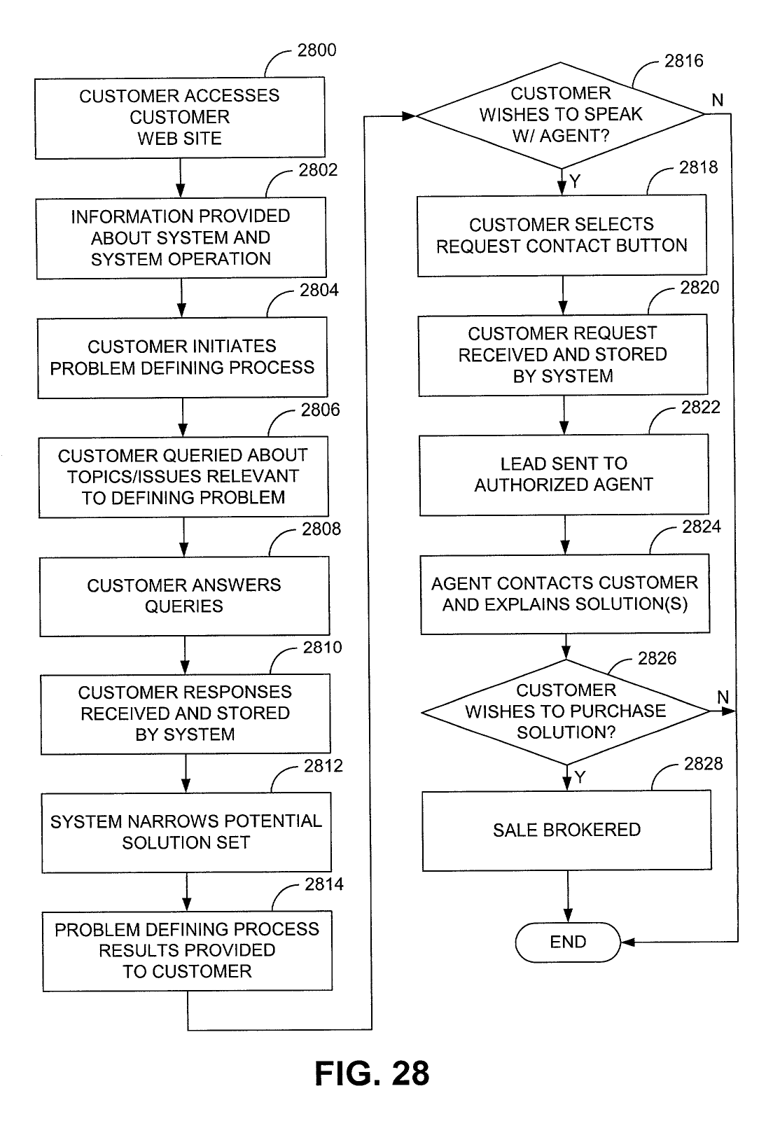

Although one aim of the system 100 is to provide electronic infrastructure for the facilitation of business relationships between agents and SPs, another objective is to integrate customers into the system to both create another channel to sales as well as to provide self-help solutions to the customers. This is the purpose for the customer web site 1500. As is discussed below, this web site 1500 can be used by customers to determine what business solutions they may need and to provide access to agents authorized to sell these solutions. Referring to FIG. 28, an example use of the system 100 is provided from the customer's perspective. As indicated in block 2800, once a customer determines that it is experiencing a problem, the customer can access the customer web site 1500 in search of a solution. At the customer web site 1500, information is provided to the customer about the system 100 and its operation, as indicated in block 2802.

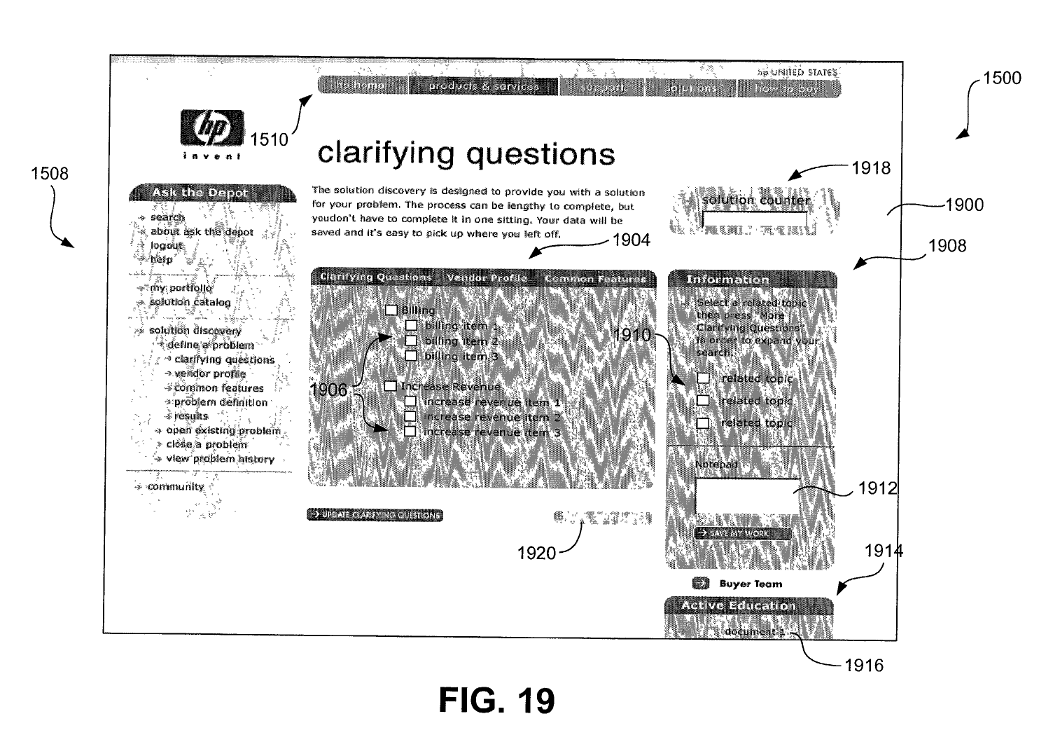

As mentioned above, the customer may not be highly knowledgeable about the nature of the problem being experienced or the appropriate software solutions for the problem. Because of this fact, the customer web site 1500 provides means to help the customer in defining the problem with particularity such that a focused solution can be generated. In such a circumstance, the customer can select the Define a NEW Problem link 1704 from the solution discovery page 1700 shown in FIG. 17 to, as indicated in block 2804, initiate the problem definition process. As described above in relation to FIGS. 18-21, the customer can then be queried on a variety of topics and issues relevant to defining the customer's particular problem, as indicated in block 2806. The customer answers these queries in the manner described above (e.g., checking check boxes associated with applicable facts), as indicated in block 2808, and the system 100 receives and stores these responses, as indicated in block 2810. Intermittently during the problem defining process the system 100 narrows the potential solution set for the customer's problem. For instance, after each entered “page” of information is entered, the system 100 determines which of the catalog of offered solutions satisfy the criteria entered up to that point by the customer. Alternatively, this current solution set can be determined upon each entry by the customer. As the customer's responses are entered, the system 100 automatically narrows the solution set through a process of elimination. The size of the solution set can be displayed to the user with a solution counter such as solution counter 1918 shown in FIG. 19 to apprise the customer as to how many solutions apply at any given time in the problem defining process.

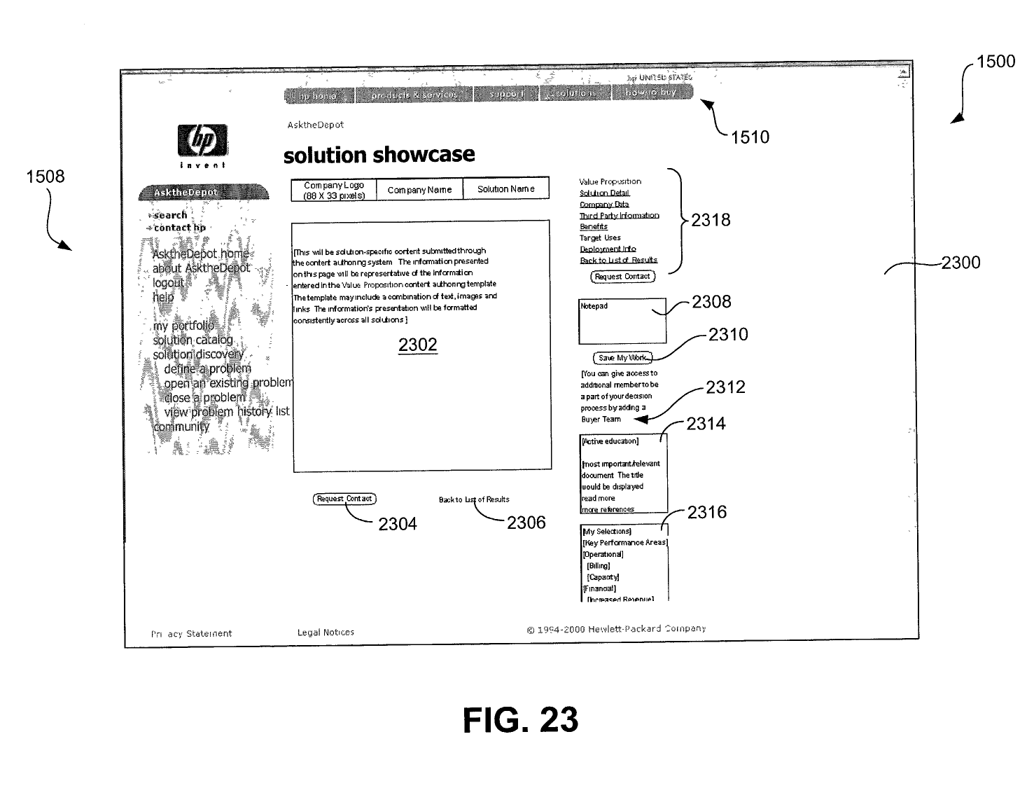

Normally, the customer responds to each query posited over each of the variety of problem defining pages described above in relation to FIGS. 19-21. After each of these pages has been completed by the customer, the system 100 displays the results of the problem defining process, as indicated in block 2814. By way of example, these results can be provided to the customer with the problem definition results page 2200 shown in FIG. 22. Alternatively, the customer can access this page at an intermediate point in the problem defining process by selecting a View Solutions button such as View Solutions button 1920 shown in FIG. 19. As described above in relation to FIG. 22, the problem definition results page 2200 can provide a summary of the problem and the potential business solutions to the problem, as well as an identification of the SPs that offer the solutions. If more information is desired, the customer can access the solution showcase page 2300 shown in FIG. 23 and/or the solution comparisons page 2400 shown in FIG. 24.

At this point, the customer can decide whether it would like an agent authorized to sell the solution to contact the customer directly, as indicated in decision element 2816. If so, the customer can select a Request Contact button, as indicated in block 2818, for instance Request Contact button 2218 shown in FIG. 22. The request is received and stored by the system 100, as indicated in block 2820 and a lead is sent to an appropriate authorized agent, as indicated in block 2822. By way of example, the agent may be an agent authorized to offer one or more of the solutions identified by the system 100 that is in the same geographical area as the customer. In such a situation, the customer can meet with the agent face-to-face. The lead can be delivered to the agent through the system, for instance by a posting to the agent's leads page 800 shown in FIG. 8. Once having received the lead, the agent can contact the customer, as indicated in block 2824, diagnose the problem, and explain an appropriate business solution in detail. Notably, in that the customer has already participated in the problem defining process, the agent's job in diagnosing the problem is greatly simplified. At this point, the customer can determine whether it wishes to purchase one or more solutions from the agent, as indicated in decision element 2826. If so, the sale can be brokered, as indicated in block 2828.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for aiding a customer with a business problem, comprising:
prompting the customer to provide information about the customer's business;
prompting the customer to provide information about a business problem the customer is experiencing;
receiving customer responses to the prompts;
automatically determining the nature of the business problem based upon the customer responses;
automatically determining a potential business solution to the problem based upon the customer responses; and
presenting a description of the business problem and the potential business solution to the customer for review such that the customer can learn about the problem and solution before speaking with an agent that sells the solution.

2. The method of claim 1, wherein the step of prompting the customer comprises prompting the customer via a customer web site and wherein the step of receiving customer responses comprises receiving customer entries made via the web site.

3. The method of claim 1, wherein the step of prompting the customer to provide information about the customer's business comprises prompting the customer to identify industries in which the customer operates.

4. The method of claim 1, wherein the step of prompting the customer to provide information about a business problem comprises prompting the customer to provide information about areas of concern to which the problem belongs.

5. The method of claim 4, wherein the step of prompting the customer to provide information about a problem further comprises prompting the customer to identify applicable issues particular to the areas of concern.

6. The method of claim 1, wherein the step of prompting the customer to provide information about a business problem comprises prompting the customer to enter a question the customer has relevant to the problem.

7. The method of claim 1, further comprising the step of intermittently determining a set of potential business solutions from a database of available business solutions as customer responses are received and presenting the set of potential business solutions to the customer.

8. The method of claim 1, further comprising the step of providing the customer with information relevant to the customer responses.

9. The method of claim 1, wherein the step of presenting a description of the business solution comprises providing a comparison of various business solutions to the customer.

10. The method of claim 1, further comprising the step of automatically sending a sales lead that identifies the customer and the problem to an agent authorized to sell a business solution to the problem via an agent web site upon the request of the customer.

11. A system for aiding a customer with a business problem, comprising:
means for prompting the customer to provide information about the customer's business;
means for prompting the customer to provide information about a business problem the customer is experiencing;
means for receiving customer responses to the prompts about the business and problem;
means for automatically determining the nature of the business problem based upon the customer responses;
means for automatically determining a potential business solution to the problem based upon the customer responses; and
means for presenting a description of the business problem and the potential business solution to the customer for review such that the customer can learn about the problem and solution before speaking with an agent that sells the solution.

12. The system of claim 11, wherein the means for prompting the customer comprises means for prompting the customer via a customer web site and wherein the means for receiving customer responses comprises means for receiving customer entries made via the web site.

13. The system of claim 11, further comprising means for intermittently determining a set of potential business solutions from a database of available business solutions as customer responses are received and means for presenting the set of potential business solutions to the customer.

14. The system of claim 11, further comprising means for providing the customer with information relevant to the customer responses.

15. The system of claim 11, wherein the means for presenting a description of the business solution comprises means for providing a comparison of various business solutions to the customer.

16. The system of claim 11, further comprising the means for automatically sending a sales lead that identifies the customer and the problem to an agent authorized to sell a business solution to the problem via an agent web site upon the request of the customer.

17. A method for aiding a customer with a business solution, comprising:
generating a customer web site that the customer can access;
prompting a customer via the web site to provide information about its business and a business problem the customer is experiencing;
receiving customer responses to the prompts entered via the web site;
automatically cross-referencing the customer responses with problem definitions and available business solutions offered via the web site to determine a set of problem definitions and potential solutions to the problems; and
presenting the set of problem definitions and potential business solutions to the customer for review.

18. The method of claim 17, wherein the step of prompting the customer to provide information about the customer's business comprises prompting the customer to identify industries in which the customer operates.

19. The method of claim 17, wherein the step of prompting the customer to provide information about a business problem comprises prompting the customer to provide information about areas of concern to which the problem belongs.

20. The method of claim 19, wherein the step of prompting the customer to provide information about a business problem further comprises prompting the customer to provide information about issues particular to the areas of concern.

21. The method of claim 17, wherein the step of prompting the customer to provide information about a business problem comprises prompting the customer to enter a particular question the customer has relevant to the problem.

22. The method of claim 17, further comprising the step of intermittently determining a set of potential business solutions from a database of available business solutions as customer responses are received and presenting the set of potential solutions to the customer.

23. The method of claim 17, further comprising the step of providing the customer with information relevant to the customer responses.

24. The method of claim 17, wherein the step of presenting the set of problem definitions and potential business solutions comprises providing a comparison of the various business solutions to the customer.

25. The method of claim 17, further comprising the step of automatically sending a sales lead that identifies the customer and the problem to an agent authorized to sell a business solution to the problem via an agent web site upon the request of the customer.

26. A web server including computer readable media, comprising:
logic configured to prompt a customer via a web site to provide information about its business and a business problem the customer is experiencing;
logic configured to receive customer responses to the prompts entered via the web site;
logic configured to automatically cross-reference the customer responses with problem definitions and available business solutions offered via the web site to determine a set of problem definitions and potential solutions to the problems; and
logic configured to present the set of problem definitions and potential business solutions to the customer for review.

27. The method of claim 26, further comprising logic configured to intermittently determine a set of potential business solutions from a database of available business solutions as customer responses are received and logic configured to present the set of potential business solutions to the customer.

28. The method of claim 27, further comprising logic configured to provide the customer with information relevant to the customer responses.

29. The method of claim 26, wherein the logic configured to present the set of problem definitions and potential business solutions comprises logic configured to provide a comparison of various business solutions to the customer.

30. The method of claim 26, further comprising logic configured to automatically send a sales lead that identifies the customer and the problem to an agent authorized to sell a business solution to the problem via an agent web site upon the request of the customer.

31. A method for selling business solutions, comprising:
providing an agent/service provider web site that agents and service providers can access;
registering an agent and a service provider with a business solution sales system of which the agent/service provider web site is a part;
facilitating authorization of the agent to sell a business solution of the service provider to a customer via the agent/service provider web site;
providing a customer web site that customers can access, the web site being configured to prompt the customer for information about the customer's business and a business problem the customer is experiencing, receive customer responses to the prompts, and automatically determine the nature of the business problem based upon the customer responses as well as a business solution to the problem; and
facilitating contact between the customer and an agent authorized to sell a business solution to the customer's problem.

32. The method of claim 31, further comprising the step of providing information to the agent about the service provider's business solutions via the agent/service provider web site.

33. The method of claim 31, wherein the step of facilitating authorization of the agent to sell comprises facilitating the agent's training and qualification.

34. The method of claim 31, wherein the customer web site is configured to provide the customer with information relevant to customer responses entered in response to the prompts.

35. The method of claim 31, further comprising the step of automatically sending a sales lead that identifies the customer and the problem to an agent authorized to sell a business solution to the problem via the agent/service provider web site upon the request of the customer.

36. The method of claim 31, wherein the business solution of the service provider is a software-based solution.
